(19) United States
(12) Patent Application Publication
(10) Pub. No.: US 2006/0055713 A1
(43) Pub. Date: Mar. 16, 2006

(54) Color display element, method for driving color display element, and display apparatus having color display element

(75) Inventors: Yasufumi Asao, Atsugi-shi (JP); Ryuichiro Isobe, Atsugi-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/531,896

(22) PCT Filed: Nov. 6, 2003
(86) PCT No.: PCT/JP03/14144

§ 371 Date: Apr. 21, 2005

(30) Foreign Application Priority Data
Nov. 6, 2002 (JP) 2002-322722
Feb. 4, 2003 (JP) 2003-027167
Oct. 31, 2003 (JP) 2003-371613

(51) Int. Cl. G09G 5/10

(52) U.S. Cl. 345/690; 345/694

(57) ABSTRACT

A color display element using a medium having optical properties modulated by an external modulation means is characterized in that the medium has a brightness modulation range where a brightness is changed by the modulation means and a color modulation range where a color is changed by the modulation means, the color display element has a unit pixel comprised of a plurality of sub-pixels including a first sub-pixel and a second sub-pixel having a color filter, and the modulation means gives modulation of the color modulation range to the first sub-pixel to display colors within the color modulation range, and gives modulation of the brightness modulation range to the second sub-pixel to display brightness of the color of the color filter within the brightness modulation range, whereby provides a color display.

### TECHNICAL FIELD

The present invention relates to a color display element capable of providing multi-color display, a method for driving a color display element, and a display apparatus having a color display element.

### BACKGROUND ART

Flat panel displays are currently widely used in various kinds of monitors for personal computers and the like, display elements for cellular phones and the like, and are expected to come into wider use than ever, including intended dissemination for use in large screen televisions in future. Among them most prevalent are liquid crystal displays, and it is a color display mode called a micro-color filter mode that is widely used as a color display mode in the liquid crystal display.

The micro-color filter mode is such that one pixel is divided into at least three sub-pixels, and a color filter of three primary colors of red (R)/green (G)/blue (B) is formed for each pixel to provide full color display, and it has an advantage that a high level of color reproducibility can easily be achieved. On the other hand, the micro-color filter has a disadvantage that the transmittance decreases by a factor of 3, and light usage efficiency is thus reduced. The reduction in light usage efficiency causes an increase in power consumption of back light of transmission liquid crystal display apparatus and front light of reflection liquid crystal display apparatus.

Recently, transflective liquid crystal elements with some areas of a display element being light reflecting areas and other areas being optically transparent areas have been widely used in cellular phones and portable information terminals. Such portable type electronic apparatus is often used outdoors, and is thus required to ensure sufficient visibility even under very bright external light and ensure a high level of contrast and color reproducibility even in a dark room.

In addition, in recent years, some display elements excellent in visibility compared to liquid crystal display elements have been reported as electric paper displays. Many of them use no polarizing plates for achieving bright display. In these display elements, however, bright display has been achieved for monochromatic display, but color display must rely on the color filter as in the case of the liquid crystal display, and it is still impossible to achieve color display with a level of brightness equivalent to that of paper.

Liquid crystal display apparatus of ECB type (electrically controlled birefringence effect type) is known as color liquid display apparatus using no color filter. The ECB-type liquid crystal display apparatus has a liquid crystal cell having a liquid crystal held between a pair of substrates and in the case of the transmission type, polarizing plates are placed on the front surface side and the back surface side of the liquid crystal cell, respectively, and in the case of the reflection type, a single polarizing plate type in which a polarizing plate is placed on only one substrate, or a double polarizing plate type in which polarizing plates are placed on both substrates and reflecting plates are provided outside the polarizing plates is available.

In the case of transmission ECB-type liquid crystal display apparatus, linearly polarized light incident through one polarizing plate is changed into light with each wavelength light being elliptical polarized light having a different polarization state by a birefringent action of a liquid crystal layer in the process of passage through a liquid crystal cell, the light enters the other polarizing plate, and light passing through the other polarizing plate becomes colored light having a color according to the ratio of light intensity of each wavelength light comprising the light.

The ECB-type liquid crystal display element colors light utilizing a birefringent action of a liquid crystal and a polarization action, in which absorption of light by a color filter does not occur, and therefore the light transmittance can be increased to obtain bright color display. In addition, since birefringent characteristics of a liquid crystal layer vary depending on voltages, colors of transmitted light and/or reflected light can be changed by controlling the voltage applied to a liquid crystal cell. By utilizing this, a plurality of colors can be displayed with the same pixel.

FIG. 1 shows a relation between a birefringent amount (called retardation R) of the ECB-type display element and coordinates on a chromaticity diagram. It can be understood that it remains achromatic in almost the center of the chromaticity diagram as long as R is in the range of 0 to approximate 250 nm, but if R exceeds this range, color changes depending on the birefringent amount.

If a material having a negative dielectric constant anisotropy (expressed by Δε) is used as a liquid crystal, and it is oriented vertically to the substrate when no voltage is applied, liquid crystal molecules are leaned with the voltage and accordingly, the birefringent amount (called retardation) of the liquid crystal increases.

At this time, the chromaticity changes along the curve of FIG. 1 under crossed Nicol. When no voltage is applied, R equals almost 0, and therefore no light is transmitted to provide a dark state (black state), but as the voltage increases, the brightness level increases in such a manner that the color changes from black to gray to white. If the voltage is further increased, light gains a color, and the color changes from yellow to red to purple to blue to yellow to purple to sky blue to green.

In this way, the ECB-type display element can change the brightness between the highest brightness and the lowest brightness with voltages in a modulation range on the low voltage side, and can change a plurality of colors with voltages in a higher voltage area.

Further, as shown in FIG. 1, colors obtained by retardation are substantively low in purity compared to colors with maximum purities at the outer edge of the chromaticity diagram. For compensating the low purity, a color filter is taken with the retardation, as disclosed in Japanese Patent Application Laid-Open No. 4-52625, so that the purity of color of an ECB display can be enhanced by passing through such a color filter of the same color. In this prior art, color filters of red colors and yellow colors are located on a pixel not displaying blue and a short wavelength ingredient of red obtained by the ECB effect is cut to obtain red with a high purity.

Hereinafter, a range of retardation of 0 to 250 nm wherein a brightness is modulated according to black to white through gray on the chromaticity diagram is referred to as brightness modulation range, and a range of chromatic modulation of yellow or more (250 nm or more) is referred to as color modulation range. Since the boundary between achromatic color and chromatic color cannot be determined, the value 250 nm regarding the above range is a tentative standard.

The present invention refers to colors obtained by retardation, which are colors along the curve in FIG. 1. As shown in FIG. 1, points at which the purity is maximum exist in the vicinities of area in which the retardations are 450 nm, 600 nm and 1300 nm, being recognized with eye as red, blue and green colors. However, there are ranges with about 100 nm width before and after these points wherein colors can be recognized as almost the same colors. Colors in the ranges are also called as red, blue and green respectively in the present invention. Magenta color exists in the vicinity of 530 nm intervening between red and blue colors.

Generally speaking, colors of color filters used in a liquid crystal display device and so forth exist outside the above ranges in the chromaticity diagram and are greater than those obtained by retardation in purity. In the present invention, these colors are also referred to as corresponding same color names, respectively.

However, for displaying a green color, the ECB-type liquid crystal display element requires a retardation amount around 1300 nm as shown in FIG. 1, and if a usual liquid crystal material is used, a significantly large thickness is required compared with a conventional liquid crystal display element.

For example, a liquid crystal element known as a VA (Vertical Alignment) mode is adjusted so that it is vertically oriented in a non-voltage application state, and a maximum retardation amount is changed to about 200 to 250 nm by application of a voltage, and a black to white brightness changing area in the ECB effect is used. An RGB color filter is provided therein to obtain full color display by an additive color mixing.

In contrast to this, for a mode in which color display is provided using a change in chromaticity by the ECB effect, i.e. retardation, the cell thickness should be increased by a factor of about 6 if the same liquid crystal material is used. Specifically, if the cell thickness of a product using a current VA mode is 4 to 5 micrometers, a color display mode using a coloring phenomenon by the ECB effect will be required to have a cell thickness of 20 to 30 micrometers.

In addition, a transflective liquid crystal display element with some areas of a liquid crystal display element being light reflecting areas and the other areas being optically transparent areas is disclosed in Sharp Technical Report No. 83, August, 2002, p. 22, and according to this report, a thick inter-layer insulation film is provided in the reflection area so that the cell thickness of the transmission area is twice as large as that of the reflection area in order to light usage efficiencies of both the transmission area and reflection area are maximized.

Employment of such a large cell thickness results in significant disadvantages as described below.

First, a spherical spacer is generally used for the purpose of uniformity of the cell thickness, but the diameter thereof becomes so large that the area of the spacer occupied over a pixel significantly increases, resulting in a reduction in numerical aperture. It is essentially desired to employ a coloring phenomenon based on the ECB effect for obtaining bright display, but the effect is reduced by half due to the reduction in numerical aperture.

The second problem with employment of a large cell is that a response speed decreases. It is generally known that the response speed is inversely proportional to a square of the cell thickness (response time is proportional to a square of the cell thickness). Thus, if the cell thickness increases by a factor of about 6, response time of the liquid crystal will increase by a factor of 36. For example, typical response time of a commercialized VA mode liquid crystal display is about 20 milliseconds, and it can thus be expected that the response time will be about 720 milliseconds in the ECB mode. That is, it is impossible to display dynamic picture images.

Furthermore, in the ECB mode, it is possible to provide color display based on a change in color utilizing a birefringence effect, but it is difficult to display smooth gray level colors during color display. Thus, display can be provided only with a limited number of colors.

Thus, the present invention provides a color display element with the light usage efficiency improved by using a mode different from a mode of displaying three primary colors simply by combining a monochromatic display element capable of modulating a transmittance by an external modulation means such as a voltage and an RGB color filter, which has been widely used. Particularly, in the liquid crystal display element based on the ECB effect, the present invention provides a color liquid crystal display element enabling dynamic picture images to be displayed by inhibiting an increase in cell thickness, and capable of providing multi-color display.

In addition, the present invention provides a transflective color liquid crystal display element having a reflection mode and a transmission mode compatible with each other, which is capable of providing multi-color display with a high light usage efficiency. This makes it possible to satisfy the need for high color reproducibility.

Furthermore, in the present invention, bright color display can be obtained for various kinds of electronic paper techniques in which the bright monochromatic display can be achieved.

### DISCLOSURE OF THE INVENTION

According to an aspect of the present invention, there is provided a color display element using a medium having optical properties modulated by an external modulation means, characterized in that the medium has a brightness modulation range where a brightness is changed by the modulation means and a color modulation range where a color is changed by the modulation means, the color display element has a unit pixel comprised of a plurality of sub-pixels including a first sub-pixel and a second sub-pixel having a color filter, and the modulation means gives modulation of the color modulation range to the first sub-pixel to display colors within the color modulation range, and gives modulation of the brightness modulation range to the second sub-pixel to display brightness of the color of the color filter within the brightness modulation range, whereby provides a color display.

According to another aspect of the present invention, there is provided a color liquid crystal display element using a liquid crystal layer having optical properties changed by application of a voltage, characterized in that the color display element comprises at least one polarizing plate, a pair of substrates provided with electrodes and so situated as to face each other, and a liquid crystal layer placed between the substrates, and has a capability of modulating incident polarized light into a desired polarized state by retardation of the liquid crystal layer, a unit pixel of the color display element is comprised of a plurality of sub-pixels, and the plurality of sub-pixels include a first sub-pixel changing retardation of the liquid crystal layer by application of a voltage to display a chromatic color, and a second sub-pixel having a color filter, and changing retardation in an achromatic area brightness modulation range by a voltage to display a color of the color filter.

According to still another aspect of the present invention, there is provided a method for providing color display using a color display element,

characterized in that a color display element is formed using a medium having a color modulation range where a color is modulated by external modulation means, and a brightness modulation range where a brightness of a color is modulated by the modulation means, a unit pixel of the color display element is divided into a first sub-pixel and a second sub-pixel having a color filter, and the first sub-pixel is made to display chromatic colors within the color modulation range, and the second sub-pixel is made to display a brightness of a color of the color filter within the brightness modulation range, whereby color display is provided.

### BRIEF DESCRIPTION OF THE DRAWINGS

FIG. 1 shows a change on a chromaticity diagram when a retardation amount changes;

FIGS. 2A, 2B, 2C, 2D, 2E and 2F each show a pixel structure of one pixel of a liquid crystal display element according to the embodiment of the present invention;

FIG. 3 is an explanatory view of a layer structure for use in the liquid crystal display element of the present invention;

FIGS. 4A and 4B are explanatory views of orientational division of the liquid crystal display element of the present invention;

FIG. 5 shows a spectrum of a magenta color filter used in the liquid crystal display element of the present invention;

FIG. 6 shows another pixel structure of the liquid crystal display element of the present invention;

FIG. 7 shows another pixel structure of the liquid crystal display element of the present invention;

FIG. 8 shows another pixel structure of the liquid crystal display element of the present invention;

FIG. 9 shows a change on the chromaticity diagram when a retardation amount changes in the liquid crystal display apparatus of the present invention;

FIG. 10 is a change on the chromaticity diagram when a retardation amount changes when a color filter complementary in color to a green color in the liquid crystal display element of the present invention;

FIG. 11 is a conceptual view showing a full color display range in the liquid crystal display element of the present invention;

FIG. 12 illustrates display colors on a red/blue plane that can be represented in the liquid crystal display element of the present invention;

FIG. 13 illustrates display colors on the red/blue plane that can be represented in another configuration of the liquid crystal display element of the present invention;

FIG. 14 illustrates display colors on the red/blue plane that can be represented in another configuration of the liquid crystal display element of the present invention;

FIG. 15 illustrates display colors on the red/blue plane that can be represented in another configuration of the liquid crystal display element of the present invention;

FIG. 16 illustrates display colors on the red/blue plane that can be represented in another configuration of the liquid crystal display element of the present invention;

FIG. 17 illustrates display colors on the red/blue plane that can be represented in another configuration of the liquid crystal display element of the present invention;

FIG. 18 shows a pixel structure of a transflective liquid crystal display element as one example of the liquid crystal display element of the present invention;

FIG. 19 shows another pixel structure of the transflective liquid crystal display element as one example of the liquid crystal display element of the present invention;

FIG. 20 shows another pixel structure of the transflective liquid crystal display element as one example of the liquid crystal display element of the present invention;

FIG. 21 shows another pixel structure of the transflective liquid crystal display element as one example of the liquid crystal display element of the present invention.

### BEST MODE FOR CARRYING OUT THE INVENTION

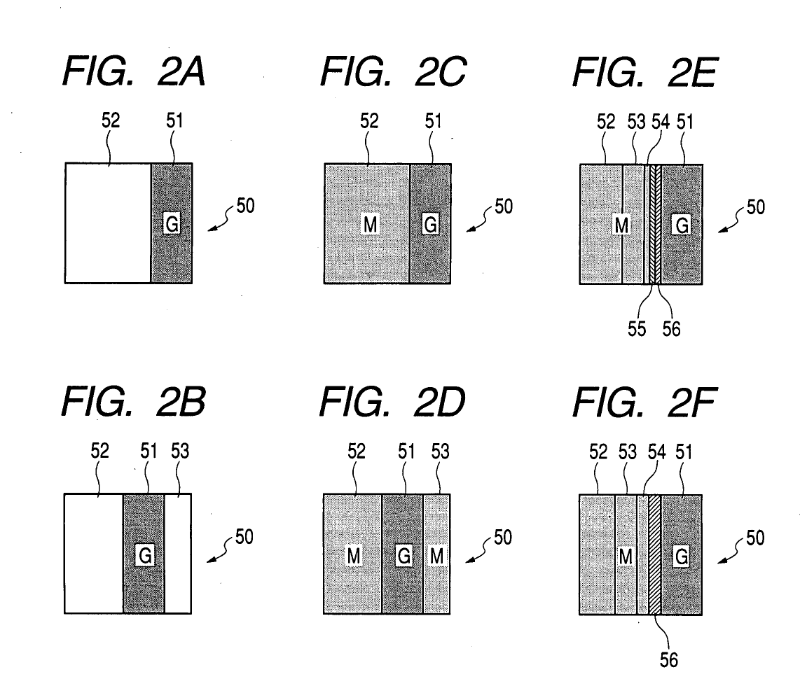

The present invention can be applied to various forms as a display element, but first the basic principle thereof will be described with reference FIGS. 2A to 2F using as an example a liquid crystal having an ECB effect.

Basic Form

In a liquid crystal display element of the present invention, as shown in FIGS. 2A to 2F, one pixel 50 is divided into a plurality of sub-pixels 51, 52 (and 53), and a green color filter is superimposed on one of the sub-pixels, namely the sub-pixel 52. For remaining sub-pixels 51 (and 53), retardation is adjusted to display an achromatic brightness change from black to white, and any color of red to magenta to blue colors. That is, the unit pixel comprises the first sub-pixel in which a retardation of the liquid crystal layer is modulated by an application of voltage to display a chromatic color, and the second sub-pixel having a color filter in which a retardation is modulated within a brightness modulation range by voltage to display a color of the color filter. The liquid crystal display element is characterized in that coloring with ECB is not utilized but a green color filter G is used for a pixel for which a green color of high visibility is displayed, and a coloring phenomenon with ECB is utilized only for red and blue colors.

For example, the green (G) pixel having a color filter is made to have a dark state, and a transparent pixel (hereinafter referring to a pixel having no color filter) is made to have a white color (state of maximum brightness in achromatic change area), whereby the white color can be displayed as entire pixels.

Alternatively, the G pixel may be made to have a (maximum) transparent state, and the transparent pixel may be made to have a magenta color in a color area. The magenta color includes both red® and blue (B) colors, and thus white display is obtained as a result of synthesis.

For providing a G single color, the G pixel is made to have a maximum transparent state, and the transparent pixel is made to have a dark state. For providing an R single color (B single color), the G pixel is made to have a dark state, and the transparent pixel is made to have a retardation value of 450 nm (600 nm). Mixed colors of R and G, and B and G are also obtained by combination.

Needless to say, if the G pixel and the transparent pixel are both made to have dark states with the retardation set to 0, black display is obtained.

In the configuration of the present invention, the G pixel has the retardation varied within the range of 0 to 250 nm, and the transparent pixel has the retardation varied within the range of 0 to 250 nm and the range of 450 to 600 nm. Usually, both the sub-pixels are common in liquid crystal material, and are therefore adjusted to have different ranges of driving voltages.

As a result of selecting a color filter for the green color, preparation of green by adjustment of retardation is avoided to eliminate the necessity to increase the cell thickness. In addition,, since the green color has a high visibility, and the image quality is improved by preparing a color having a high purity with a color filter. The present invention is characterized in carrying out the display of G-pixel with the aid of a color filter, and displaying each of the other colors with a color generated by a medium itself, which is a liquid crystal in the above-mentioned case. Such a constitution can be applied to others than liquid crystal. That is, generally speaking, the present invention can be applied to any case provided that such a case employs a medium an optical property of which is altered by a modulation means added from external, and the medium has a modulation range modulating a color and a modulation range modulating a brightness by a modulation means. Such a medium, concrete examples of which are explained later, may be used in the following steps: a display device is fabricated using such a medium; a unit pixel is comprised of a transparent first sub-pixel and a second sub-pixel having a color filter; a modulation enabling a color to modulate within a specific range is applied to the first sub-pixel to make the sub-pixel display the color in the range; and a modulation within a brightness modulation range is applied to the second sub-pixel to make the sub-pixel alter the brightness of a color of the color filter. Applying to the transparent first sub-pixel a modulation within the brightness modulation range makes it possible to display achromatic colors of black, gray and white.

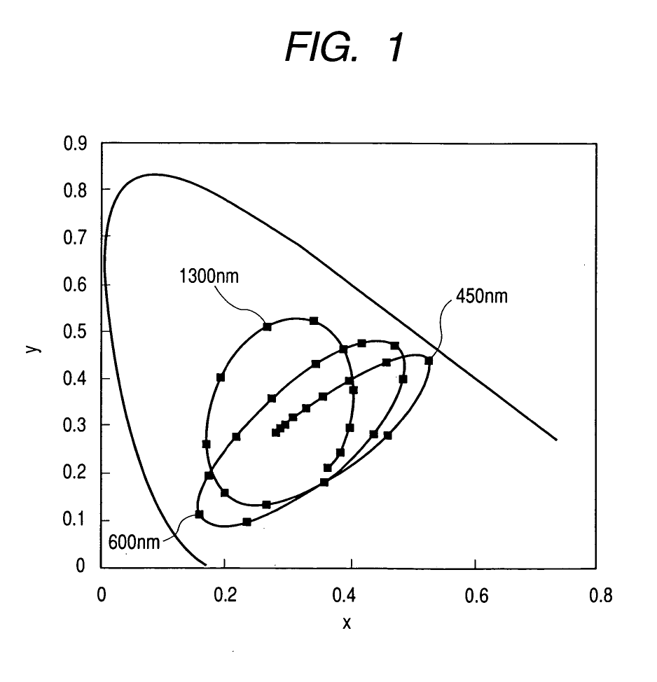

According to the present invention, the necessity to extremely increase the cell thickness is eliminated compared to liquid crystal display elements that are usually used. According to FIG. 1, the red has a retardation value of 450 nm, the blue has a retardation value of 600 nm. Thus, the cell thickness should be set to a level for achieving a retardation value of 600 nm. In the above example, the cell thickness should be only about 10 micrometers. As long as the cell thickness is kept at such a level, the response speed does not significantly increase, but remains at about 150 milliseconds, and dynamic picture images can be displayed although somewhat blurring occurs.

In addition, if this is applied to a reflection liquid crystal display element, the cell thickness decreases by half so that the response speed drops by a factor of 4 to 40 milliseconds or less, which is a level at which dynamic picture images can be displayed almost without any problems.

In addition, since the color reproduction range of green depends on the color filter, and the visibility is high, a high level of color reproducibility can be achieved without sacrificing the transmittance of a white color component.

As described previously, gray level display in color display is difficult in the ECB mode but in the present invention, continuous gray level display of green color can be provided, and therefore it is not recognized for human eyes that gray level characteristics are significantly impaired, and thus relatively good color images can be obtained.

The cell thickness of the green pixel such that display of the λ/2 condition can be provided in the case of transmission type and display of the λ/4 condition can be provided in the case of reflection type is sufficient, and therefore can be reduced compared to modes using coloring with ECB including conventional green colors and as a result, the response speed of the green pixel can be enhanced.

That is, for the element of the present invention, the response speed of the green pixel having high visibility characteristics is increased, and therefore high-speed display can be provided for human eyes. Furthermore, in the pixel having no color filter in the example described above, coloring with ECB is utilized when a voltage is applied, and therefore display of red and blue is driven with a high voltage. Accordingly, high-speed display resulting from high-voltage driving is provided for red and blue pixels, and the response speed is increased in correspondence with the reduced cell thickness d2 for the green pixel, thus making it possible to inhibit variations in response speed between colors.

In the present invention, display of digital gray levels can be provided by dividing into sub-pixels a pixel using a coloring phenomenon based on the ECB effect. On the other hand, in the case where the pixel is not divided into such sub-pixels, the number of displayable gray levels is limited to two values of brightness and darkness, the number of sub-pixels required for one pixel can be reduced from 3 to 2 compared to the case where conventional RGB filters are used. Consequently, when the number of driver ICs is the same, an effective number of pixels can be increased by a factor of 1.5 to obtain display of high resolution. Alternatively, for obtaining the same number of pixels, the number of required driver ICs can be reduced, thus making it possible to obtain a low cost panel. Furthermore, for the above problem of the number of gray levels, image processing such as dither may be used. As a result, subtle graininess may remain, but gray level display can be provided. In addition, it can be considered that this graininess becomes hard to be visually recognized as the pixel density is subsequently enhanced.

Gray Level Display

In the liquid crystal display element of FIG. 2A, continuous gray level display can be provided for the green pixel having high visibility characteristics, but gray level display cannot be provided for chromatic states of transparent pixel areas, i.e. blue and red because coloring with ECB is utilized.

FIG. 2B shows an improvement in this respect, the transparent pixel is divided into a plurality of sub-pixels 51 and 53, and the ratio of their areas is changed to digitally represent gray levels.

As the sub-pixels have different areas, half tones are displayed in some degrees according to areas of sub-pixels being turned on and displaying colors are displayed.

At this time, when the number of the sub-pixels is N, the transparent pixel is divided so that the ratio of their areas is 1:2: . . . : 2^{N-1}, whereby gray level characteristics of high linearity can be obtained. In the example of FIG. 2B, the number of sub-pixels is 2 (N=2).

In the liquid crystal display element of the present invention, the digital gray level is used only for red and blue having low visibility characteristics. Adding continuous modulations in a range of 0 to 250 nm to the green pixel makes it possible to display a continuous tone. As a result, eye of man has no sense of feeling that the tone has been substantively marred so that the relatively good color image can be obtained. That is, the present invention is also characterized in that the digital gray level is used only for red and blue having a limited number of gray levels that can be sensed by human eyes, whereby sufficient characteristics can be provided even with a limited number of gray levels.

Furthermore, for having sufficient gray scale characteristics sensed even with a limited number of gray scale levels as described above, a smaller pitch is more preferable. Specifically, the pitch is desirably 200-micrometers or smaller in terms of a resolution at which humans can no longer identify pixels.

### EXAMPLE OF APPLICATION

As described above, the liquid crystal display element of the present invention takes a display method utilizing a coloring phenomenon based on the ECB effect for red and blue colors, thus making it possible to significantly reduce an optical loss compared to the case where color filters are used for red and blue colors, respectively. As a result, an element having a higher light usage efficiency can be obtained compared to the conventional mode in which three primary colors are displayed only with RGB color filters. Thus, the liquid crystal display element of the present invention can be used as a reflection liquid crystal display element in paper-like display or electronic paper.

On the other hand, in this mode, even a transmission liquid crystal display element has a liquid crystal layer of high transmittance, and therefore reduces back light power consumptions required for obtaining a brightness equivalent to that of the conventional mode, and is thus suitably used in terms of reduction of power consumptions.

Furthermore, owing to high-speed responsiveness, the display element of the present invention can also be used for display of dynamic picture images. As for liquid crystal elements for use in televisions, a drive method referred to as “quasi impulse driving” in which a backlight shutoff period is provided within one frame period for achieving clear dynamic picture image characteristics has been previously proposed in Japanese Patent Application Laid-Open No. 2001-272956 or the like, but the method has a problem such that the brightness is reduced in association with provision of the shutoff period. For such a use, a display element having an increased response speed and a high transmittance like this mode can be applied.

The display element is also suitably used in a projection display element that is required to have a high light usage efficiency.

### ALTERATION EXAMPLES

In the example described above, the analog gray level is achieved by using a color filter for green color display, and the digital gray level is achieved in red and blue display by utilizing a coloring phenomenon based on the ECB effect and a display method based on the pixel division process for red and blue colors. This example is suitably used in application of high definition display elements for having sufficient gray level characteristics sensed even with a limited number of gray levels.

On the other hand, in the reflection liquid crystal display element, there are applications in which a high degree of reflectance and a lager number of display colors are required. In addition, in transmission liquid crystal display elements capable of providing full color display, there are needs for a display mode of high transmittance for reducing back light power consumptions while maintaining the full color display capability. In addition, there are quite many needs for a display mode capable of providing full color display and having a high light usage efficiency, such as a liquid crystal projector having a high light usage efficiency.

For meeting such needs, methods in which the number of colors can be increased with this mode as a base include:

(1) method of utilizing the coloring phenomenon with the ECB effect in retardation values, other than those of red and blue colors;

(2) method of utilizing continuous gray level colors in a low retardation range of a pixel provided with a color filter complementary in color to green; and

(3) method of adding a pixel provided with any one of color filters of red and blue colors. Each of the above methods will be described below.

### Alteration Example 1

### Method of Using Coloring Phenomenon with ECB Effect in Retardation Values Other than those of Red and Blue Colors

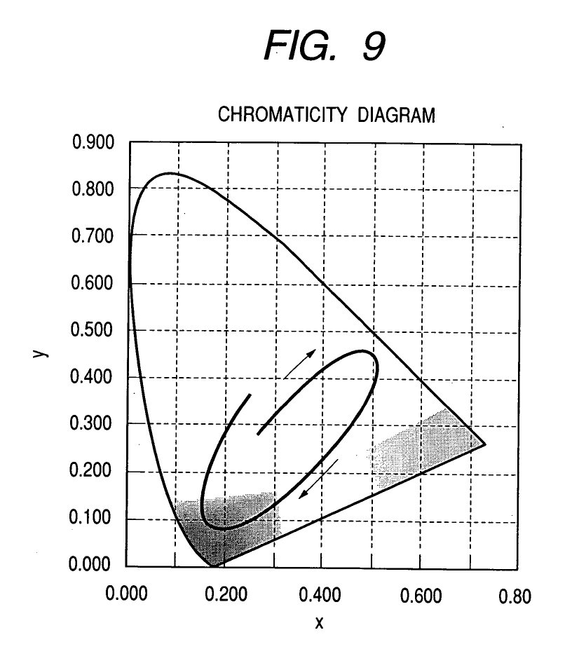

A principle of providing red and blue display utilizing a coloring phenomenon with the ECB effect has been described above. In this coloring phenomenon with the ECB effect, the color tone can be continuously changed from the white color to the blue color as shown in FIG. 9. That is, a large number of display colors capable of being used exist in addition to the red and blue color display described above and by using such display colors, a larger number of display colors than those described above can be represented. Specifically, to describe a display color change under the crossed Nicol in a configuration where the sub-pixel 1 is provided with no color filter, an achromatic brightness change from black display to gray (intermediate tone) to white display occurs as the retardation amount increases from zero as shown by the arrow mark in FIG. 9, and various chromatic colors can be changed from yellow to yellowish red to red to reddish purple to purple to bluish purple to blue in the range of retardation amounts exceeding a white range.

By combining the achromatic range with the green pixel, bright green display can be provided. Any chromatic color in the chromatic range may be combined with the green pixel to display an intermediate color.

In addition, these chromatic colors can represent digital gray levels with the above configuration as in the case of the red/blue colors. Consequently, a larger number of display colors can be represented.

### Alteration Example 2

### Method of Utilizing Continuous Gray Level Colors in Low Retardation Range of Pixel Provided with Color Filter Complementary in Color to Green

If no color filter is used in the sub-pixel 1 as in the basic form and alteration example 1, a color tone change from yellow to yellowish red to red to reddish purple (magenta) to purple to bluish purple to blue is shown in the range of retardation amounts exceeding a white range. In this alteration example, the sub-pixel 1 colored by a retardation change is provided with a color filter such as magenta or the like complementary in color to green. Consequently, the color reproduction range of red and blue colors can be significantly widened.

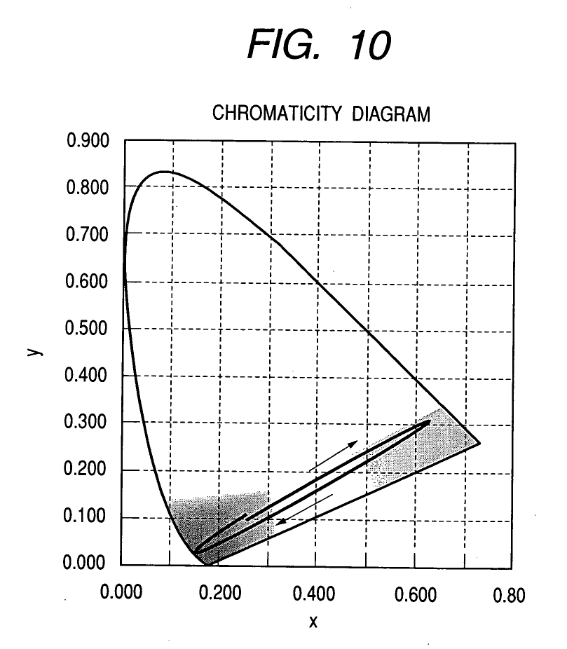

FIGS. 2C and 2D show a pixel configuration of this alteration example. A G pixel 51 is provided with a green color filter identical to that of the basic form, and the sub-pixel 1 (52, 53) that is transparent in the basic form and alteration example 1 is provided with a color filter of magenta color. FIG. 2C shows the case where there is one sub-pixel 1 (52), and FIG. 2D shows the case where the sub-pixel 1 is divided two sub-pixels (52, 53) in the ratio of 2:1. A modulation of a range wherein brightness is modulated is given to the second sub-pixel 51 (G-pixel) to change a brightness of the green color; a modulation of a range wherein color is modulated is given to the first sub-pixel (52, 53) to display a chromatic color; and a modulation of a range wherein the brightness is modulated is given, to carry out a displaying in which a brightness of magenta color is altered. In FIG. 10 are shown calculated values of color change with retardation where an ideal magenta color filter is provided such that the transmittance is 0 in wavelengths of 480 nm to 580 nm and the transmittance is 100% in other wavelengths. A brightness change in chromatic colors from black display to dark magenta color (intermediate tone of magenta color) to bright magenta display is exhibited as the retardation amount increases from zero. Thereafter, when the retardation amount further increases to reach to a level in the range of retardation amounts exceeding a white range in the example in which no color filter is used for the sub-pixel 1, a continuous change in chromatic colors from magenta to red to reddish purple (magenta) to purple to blue is exhibited.

In comparison with FIG. 9, the range of chromaticity change expands to near saturated colors of red and blue (corners of chromaticity diagram), and it can be thus understood that the color reproduction range of red and blue is widened by providing a magenta color filter. In addition, a change from red to blue proceeds along the lower side of the chromaticity diagram, it can also be understood that a continuous change in mixed color from red to bleu is obtained. In this way, by providing a magenta color filter, the color reproduction range of red and blue is widened and at the same time, a continuous change in intermediate color is obtained when the retardation change occurs.

For displaying a white color in this embodiment, magenta pixels 52 and 53 (referring to sub-pixel 1 in this embodiment) and the G pixels 51 are both set to a same retardation value (250 nm) giving a maximum transmittance. Alternatively, the G pixel 51 may be made to have a maximum transparent state (retardation value of 250 nm), and magenta pixels 52 and 53 may be set to retardation values at some middle levels between red and blue (near 550 nm). In the case of the former method, for changing the brightness in achromatic colors, the retardation of the magenta pixel may be changed according to the retardation of the green color filter pixel so that gray levels of both sub-pixels are harmoniously changed.

If a black color is display, respective single colors of G/R/B are displayed, or mixed colors thereof are displayed, operations are performed in the same manner as in the basic form.

Gray level representation when the magenta pixel is divided into two pixels is similar to that of FIG. 2B in the basic form.

By using a color filter complementary in color to the green color such as the magenta color as in this alteration example, achromatic gray level representation can be provided and at the same time, gray level representation of a color complementary in color to the green can be provided, thus making it possible to significantly increase the number of display colors capable of being represented.

Magenta color filters transmits both red and blue so that a bright display in comparison with that in a conventional method wherein red and blue color filters are set can be obtained.

### Alteration Example 3

### Method of Adding Pixel Provided With Any One of Color Filters of Red and Blue Colors

FIG. 2E shows a pixel configuration of this alteration example. In this alteration example, a third sub-pixel 55 having a blue color filter and a fourth sub-pixel 56 having a red color filter are added in addition to the G pixel 51 and magenta pixels 52, 53 and 54 (three-way divided in the ratio in area of 4:2:1).

Display actions of the G pixel and magenta pixels are same as those of the previous embodiment, and the G pixel is modulated in a low retardation range to provide continuous gray level display of green brightness. Magenta pixels are continuously modulated in the same retardation range or a larger chromatic retardation range to exhibit a blue color or red color and an intermediate color.

For third and fourth sub-pixels 55 and 56, the retardation is modulated within the range of 0 to 250 nm, and the brightness of blue and red continuously changes. Their roles will be described below.

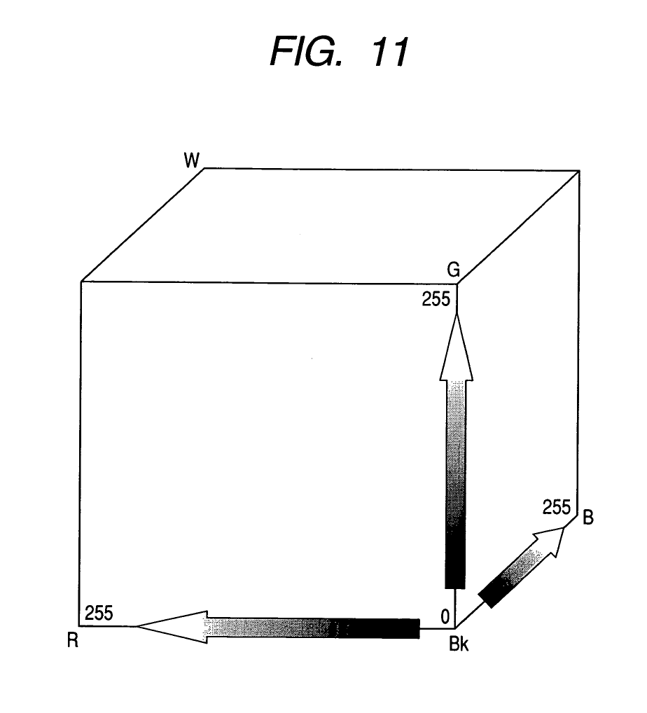

FIG. 11 shows display colors that can be displayed with the RGB additive color mixture mode, in which any point in the cube indicates a state of color mixture of red/blue/green corresponding to the coordinate value, and the apex shown by Bk indicates a state of minimum brightness. Here, when image information signals of red/green/blue are given, a display color corresponding to a position of a sum of R/G/B independent vectors extending from the Bk point is displayed.

R/G/B in the figure indicate states of maximum brightness of red/green/blue, respectively, and W indicates a white color display state. Furthermore, the length of one side is 255.

Here, in the display element of the present invention, continuous gray level display is provided using a color filter for the green color, and therefore any point can be individually taken in the direction of green. Thus, when display colors are discussed later, they will be discussed on a plane comprised of red/blue vectors (hereinafter referred to as RB plane).

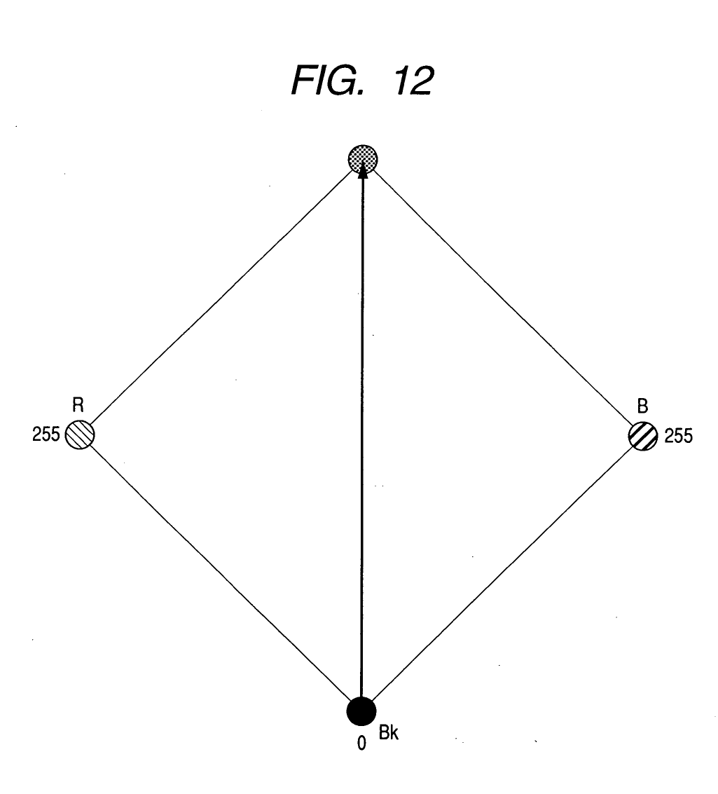

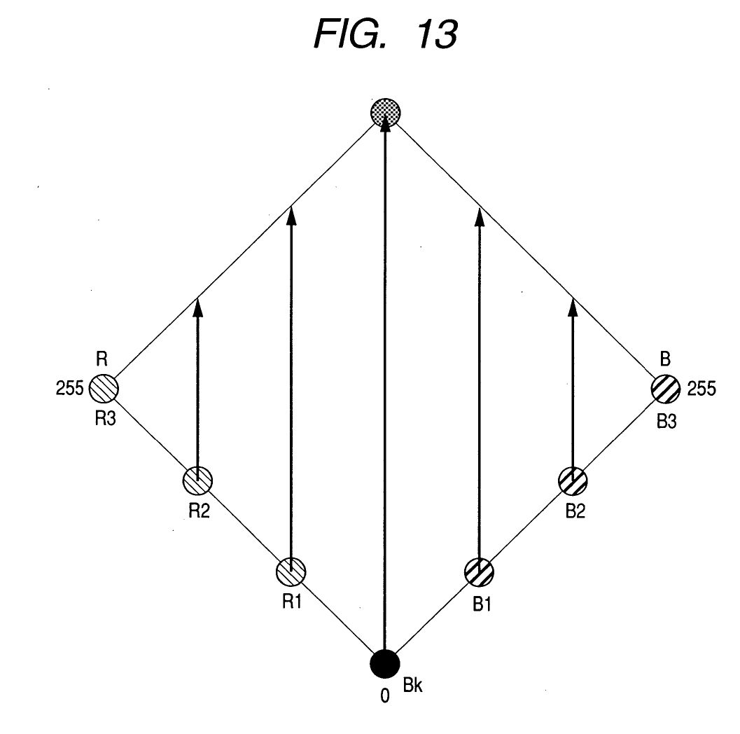

First, the case of one pixel that utilizes a coloring phenomenon based on the ECB effect (case where the pixel is not divided) will be described using FIG. 12. FIG. 12 shows an RB plane. Here, the coloring phenomenon based on the ECB effect is used during red display and blue display, and it is two values of on and off that can be taken as bright and dark display states. Thus, it is two points of a maximum value (R, B) and a minimum value (Bk) that can be taken on axes of R and B.

On the other hand, in the configuration described in the alteration example 2, i.e. in the case where a magenta color filter complementary in color to green is provided, the brightness of magenta color can be changed by changing the retardation of the magenta pixel within the range of 0 to 250 nm. Display colors within this range exist on the axis along the direction of a combined vector of R and B shown by the arrow mark in FIG. 12 on the RB plane, which accounts for exhibition of a continuous change in brightness. That is, in the alteration example 2, the Bk point (original point), the R point, the B point and any point on the arrow mark can be used as display colors.

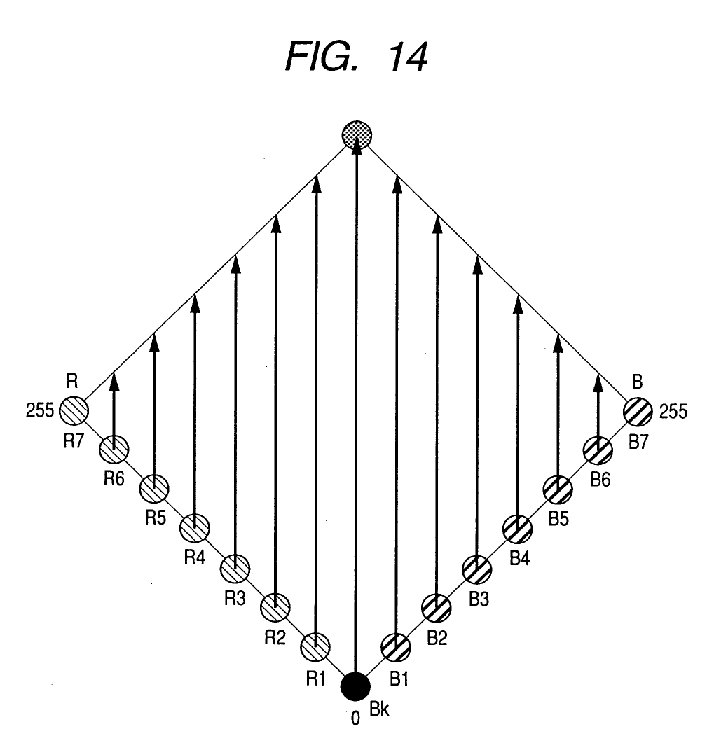

The case where the pixel using a coloring phenomenon based on the ECB effect is divided in the ratio of 1:2 will now be described using the RB plane shown in FIG. 13. Here, as in the case where the pixel is not divided, the coloring phenomenon based on the ECB effect is used during red display and blue display, and therefore it is two values of on and off that can be taken as bright and dark display states for each single divided pixel. On the other hand, because the pixel is divided into two pixels in the ratio of 1:2, it is four points shown by the circle mark in the figure that can be taken on each of R and B axes.

Here, at each of the points shown by R3 and B3 in the figure, both two pixels are in red display or blue display states.

At each of the points shown by R1 and B1, a smaller pixel of divided pixels is a red display state or blue display state, and the other larger pixel is in a black display state. Here, for the larger pixel, continuous gray level colors of magenta can be taken, and therefore any point on the arrow mark extending along the direction of a RB combined vector from each of R1 and B1 points can be taken. Based on the same discussion, any point on the arrow mark extending along the direction of a RB combined vector from each of R2 and B2 points can be taken. That is, the first sub-pixel with a magenta color filter is divided into two sub-pixels having different areas one of which is made to display a chromatic color of red or blue and the other of which is made to carry out the displaying of changing the brightness, whereby a digital halftone of magenta is displayed. The green pixel can change the brightness continuously, whereby it is possible to carry out the color display.

Based on the same discussion, display colors that can be taken when the pixel using the coloring phenomenon based on the ECB effect is divided in the ratio of 1;2;4 are shown by arrow marks in FIG. 14.

In general, it makes possible to display a digital magenta halftone that a magenta color filter is located on the first sub-pixel, which is a sub-pixel utilizing a coloring phenomenon based on ECB effect, the sub-pixel is divided into a plurality of sub-pixels having different areas to make a part of the sub-pixels display red or blue according to ECB effect and to make the others carry out the displaying which changes the brightness, whereby a digital magenta halftone can be displayed.

In this way, as the number of divided pixels is increased, the number of display colors that can be taken on the RB plane increases. However, this method is strictly associated with the digital gray scale, not analog full color display.

Then, in this alteration example, pixels (55 and 56 in FIG. 2E) having red and blue color filters are added for obtaining an analog gray scale. These pixels create continuous brightness changes of blue and red, respectively, and are therefore expressed by vectors variable in magnitude along B and R axes on FIGS. 13 and 14. Consequently, continuous gray scales of red and blue colors can be displayed, and therefore interpolations can be made for areas other than those on arrow marks in FIGS. 13 and 14, thus making it possible to represent all points on the RB plane.

That is, the second sub-pixel, which functions as only brightness modulation, is divided into a plurality of sub-pixels, one of the plurality of sub-pixels is provided with a green color filter, the others are provided with color filters of red and/or blue colors. A modulation of a range wherein the brightness is modulated is given to each of the second sub-pixels to cause a change in brightness, whereby a continuous halftone is added to the above-explained digital magenta halftone displaying so that an optional halftone on RB plane can be displayed. Thereto a green continuous tone is combined, whereby the full-color displaying can be carried out.

Since the pixel of the second sub-pixels on which red and blue color filters have been located fills up an interval between digital magenta tones displayed by the first sub-pixels, it is sufficient that the modulation is performed so that the highest brightness is almost equal to the brightness displayed by the smallest sub-pixel of sub-pixels comprising the first sub-pixel.

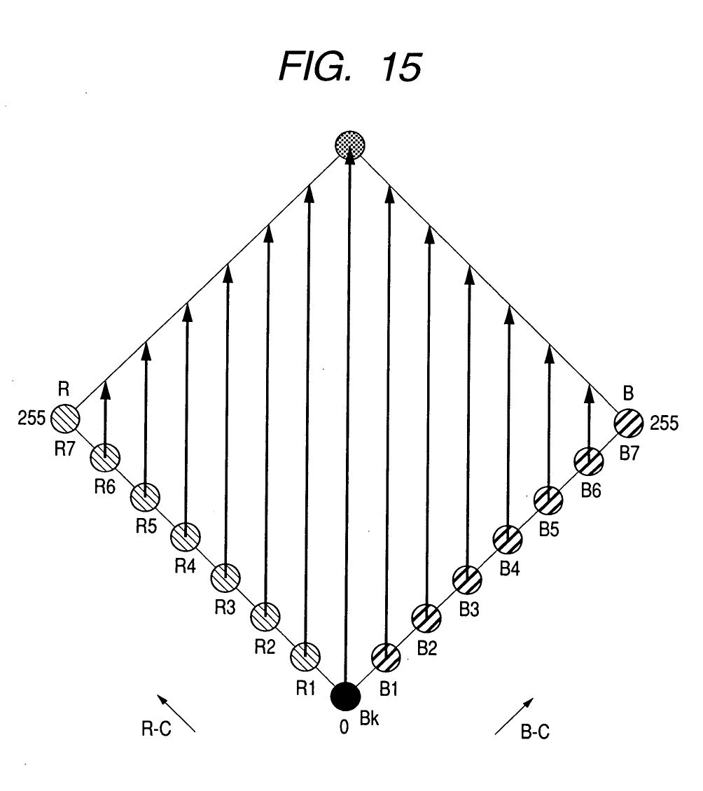

The sizes of pixels 55 and 56 having red and blue color filters, which are added at this time, may be no greater than an area equivalent to that of the sub-pixel 54 of which the area is the smallest of the sub-pixels 52, 53 and 54 obtained by dividing the pixel as described above. That is, in FIG. 14, for example, displayable points I the range of from the Bk point to R7 and B7 points each shown by a circle mark are arranged at equal intervals. Any point on the arrow mark extending along the direction of the RB combined vector from the circle mark can be taken. To the configuration capable of displaying such colors are added pixels 55 and 56 having red and blue color filters, which have areas equivalent to that of the sub-pixel of which the area is the smallest of those of divided sub-pixels, whereby any point on the arrow marks shown as R-CF and B-CF in FIG. 15 can be subjected to additive color mixture. Consequently, all points on the RB plane can be represented, thus making it possible to provide perfect analog full color display.

In addition, as described above, the sizes of pixels having red and blue color filters, which are added, may be no greater than an area equivalent to that of the sub-pixel of which the area is the smallest of the sub-pixels and obtained by dividing the pixel as previously described, and therefore the larger the number of divided pixels, more significantly the influence of a drop in light usage efficiency associated with use of red/blue color filters can be alleviated. That is, the larger the number of pixels into which a pixel using a coloring phenomenon based on the ECB effect is divided, the higher light usage efficiency can be achieved.

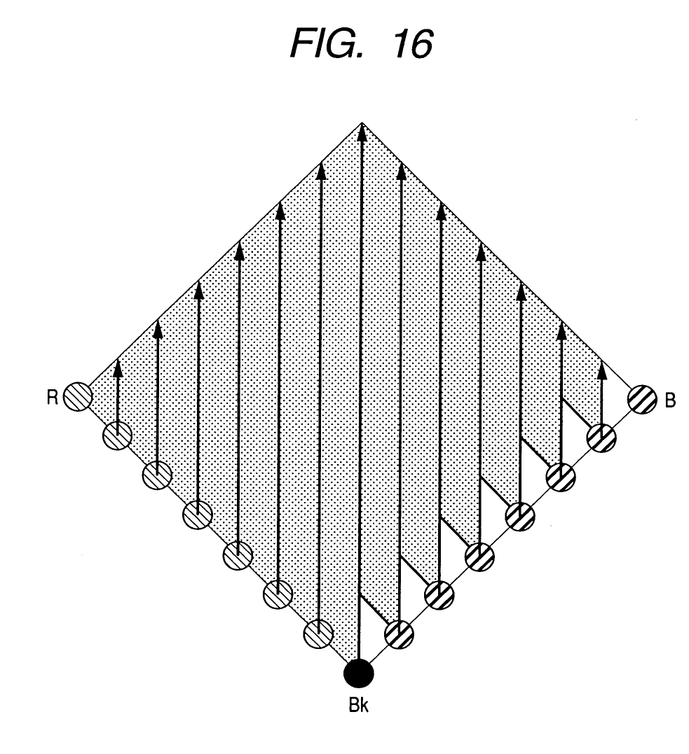

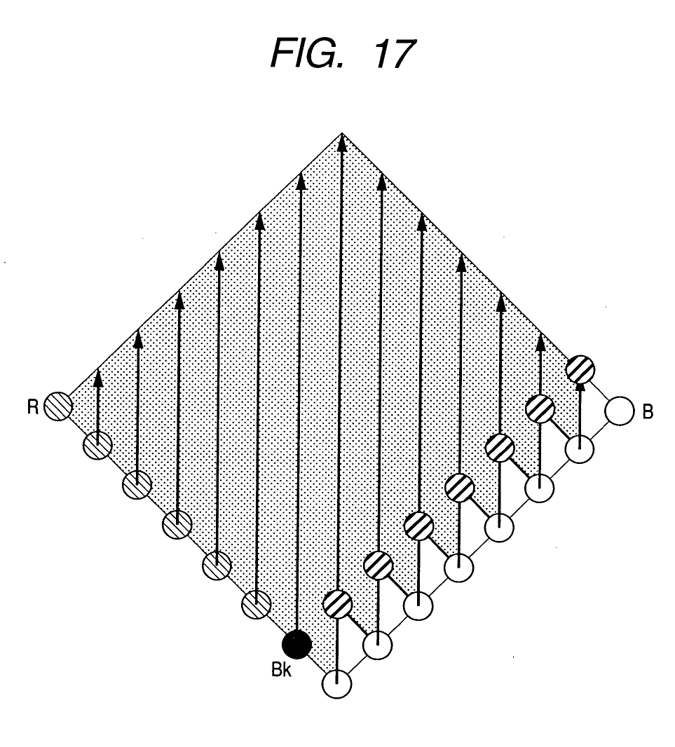

Furthermore, at this time, an effective effect can be achieved even if both of red and blue color filters are not added. FIG. 2F shows an example thereof, in which there exists only the pixel 56 having a red color filter. A range of displayable colors when only a red color filter is added is shown as a hatched area in FIG. 16. In this figure, all colors can be represented in the red direction, but display colors incapable of being represented exist in the blue direction. For visibility characteristics of human beings, however, the blue color is most insensitive, and it is thus considered that the blue color may have a least number of gray levels. Therefore, by adding only a red color, display colors equivalent full colors can be obtained.

In addition, by shifting the Bk point as a reference to the R1 position in FIG. 15, in a configuration identical to that shown in FIG. 16, all display colors can be represented. Furthermore, at this time, the black display state changed to a slightly reddish display color, but such a method can be used in applications such as reflection display elements, for example, in which requirements for contrast are not so much strict compared to transmission display elements.

By the method described above, full colors or display colors equivalent to full colors can be represented.

Applicable Liquid Crystal Display Mode

The present invention can be applied to a variety of liquid crystal display modes described below.

The above VA mode makes liquid crystal molecules in the liquid crystal layer orientate in the almost perpendicular direction to a face of substrate when no voltage is applied to the liquid crystal molecules, and makes the molecules incline against the almost perpendicular direction when a voltage is applied thereto, to change the retardation.

In OCB (Optically Compensated Bend) mode, the retardation is changed by changing the orientation state within the range between the bend orientation and the almost perpendicular orientation. Accordingly, the OCB mode is the same as VA mode in a viewpoint that the present invention can be applied thereto.

In the present invention, display colors with changes in retardation are utilized, and thus consideration must be given to a change in color tone by a viewing angle. However, the current advancement of development of LCDs are so remarkable that it is no exaggeration to say that the problem of dependence on viewing angles has been almost solved in color liquid crystal displays using RGB color filter modes. For example, in the OCB (Optically Compensated Bend) mode, it has been reported that a self compensation effect by bend orientation inhibits a change in retardation associated with a change in viewing angle. Also, in the STN mode, viewing angle characteristics have been significantly improved as development of retardation films have been advanced. The present invention can also be applied to the OCB and STN modes because in these modes, a coloring phenomenon based on the ECB effect can be obtained by setting the retardation amount as appropriate. Particularly in the OCB mode, a considerable improvement can be made for the response speed described previously, and therefore the mode is suitably used in applications in which high speed performance is required.

On the other hand, the MVA (Multidomain Virtical Alignment) mode has been already commercialized as a mode having excellent viewing angle characteristics, and widely used. In addition, a mode called PVA (Patterned Virtical Alignment) mode is widely used.

In these vertical orientation modes, wide viewing angle characteristics are achieved by providing irregularities on the surface (MVA) and adjusting electrode forms (PVA) to control the direction in which liquid crystal molecules are leaned. The configuration of the present invention can be applied to these modes because they are modes in which the retardation amount is changed with a voltage. In this way, a liquid crystal display element satisfying requirements of a high transmittance (or reflectance), a wide viewing angle and a large color space at the same time can be achieved.

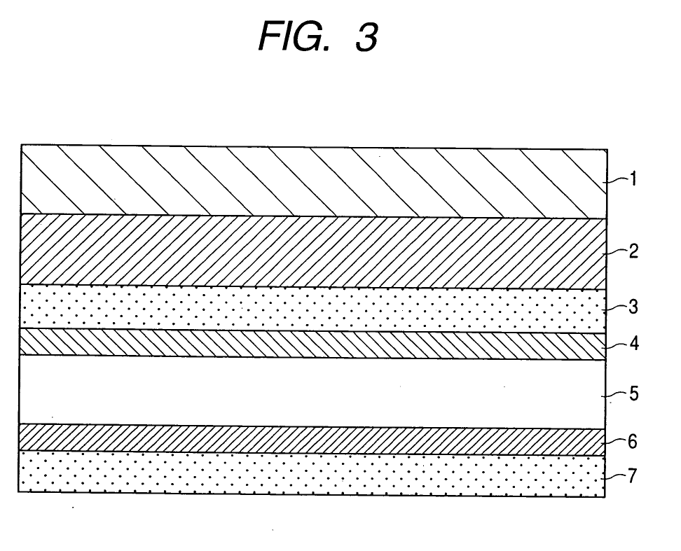

Furthermore, FIG. 3 shows a configuration of a reflection liquid crystal element for use in the present invention, and the reflection liquid crystal element comprises a polarizing plate 1, a phase compensation plate 2, a glass substrate 3, a transparent electrode 4, a liquid crystal layer 5, a transparent electrode 6, and a glass substrate 7 having a reflecting plate on the surface. A principle enabling bright and dark display to be provided will be briefly described.

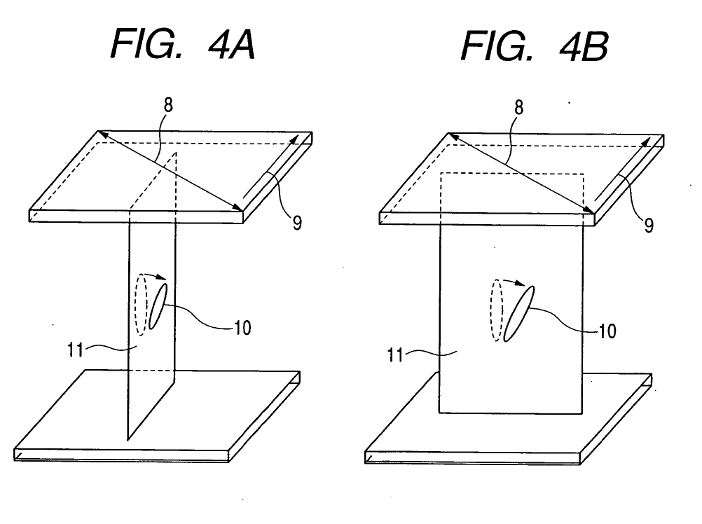

First, for the sake of simplification, the liquid crystal layer 5 is not orientationally divided. Furthermore, for the sake of simplification, only a wavelength of 550 nm (single wavelength) is used. The phase compensation plate 2 is uniaxial, the retardation amount thereof is 137.5 nm, and a delay phase axis is situated at an angle of 45 deg. clockwise (viewed from a polarizing axis 8 of the polarizing plate 1). In addition, the liquid crystal layer 5 is vertically oriented when no voltage is applied, and will be described using so called a VA mode in which molecules are leaned by application of a voltage. At this time, liquid crystal molecules are leaned in a direction of 45 deg. clockwise (viewed from a polarizing axis 8 on the polarizing plate side) relative to the polarizing plate 1. A situation at this time is shown in FIG. 4A. Furthermore, in this figure, reference numeral 9 denotes an optical axis of the phase compensation plate 2.

An external light passed through polarizing plate 1 is divided to a polarization ingredient in the direction of optical axis 9 of the phase compensation plate and a polarization ingredient perpendicular to the former one.

Each ingredient passes through the phase compensation plate 2 and liquid crystal layer 5 twice, respectively, in a manner of going back and forth therebetween. As a result, a phase difference causes between the ingredients, a value of which is given as a sum of a retardation of the phase compensation plate and a retardation of the liquid crystal layer, outputting again through the polarizing plate.

In the configuration described above, the retardation value of the liquid crystal layer 5 is 0 because of the vertical orientation if no voltage is applied to the liquid crystal layer 5. Therefore, the reflectance T % in the above configuration is expressed by the following equation.
T %=cos²(π×2×137.5/550)=0 (equation 1)

In this way, the reflectance when no voltage is applied is 0, i.e. it is a normally black configuration.

Now, the case where a voltage is applied will be examined.

At this time, application of a voltage causes liquid crystal molecules to be leaned in a direction parallel to the phase compensation plate 2. Thus, provided that the amount of retardation occurring in the liquid crystal layer 5 as liquid crystal molecules are leaned is R(V), the reflectance T % (V) when a voltage is applied is expressed by the following equation.
T%=cos²(π×2×(137.5+R(V)/550) (equation 2)

In this way, a desired reflectance consistent to the voltage can be obtained. Although it is supposed in the above explanation that the liquid crystal molecules incline parallel to the optical axis direction of the phase compensation plate, the inclining direction of the liquid crystal molecules is not limited thereto but may be in an optional direction because a light passed through the phase compensation plate turns to a circularly polarized light.

In addition, a CPA (Continuous Pinwheel Alignment) mode has been proposed as an orientation mode taking a vertical orientation state when no voltage is applied, which is similar to the mode described above. ((Non-Patent Document 2) Sharp Technical Report: No. 80/August, 2001, p. 11).

This mode is such that the electrode form is adjusted to control the direction in which liquid crystal molecules are leaned when a voltage is applied as in the case of the PVA mode described above. This mode has an orientation state in which liquid crystal molecules are leaned in a radial form from the center of the sub-pixel when a voltage is applied, thereby achieving the widening of a viewing angle. The present invention can also be applied to this CPA mode because it is a mode in which the retardation amount is changed with a voltage.

Furthermore, the Non-Patent Document 2 describes that by using a reverse TN mode using a liquid crystal material with a chiral material added thereto for improving the transmittance of the liquid crystal, a birefringent nature and a wave guide property can be used in conjunction, and therefore the light usage efficiency is improved. The addition of a chiral material can also be applied in the configuration of the present invention.

However, in the configuration of the present invention, in the case where a reflection liquid crystal and also circularly polarizing plate is used, a satisfactory reflectance can be obtained even if no chiral material is added in the CPA mode. This will be described below.

A configuration having stacked three layers of layers of (1) circularly polarizing plate, (2) liquid crystal layer and (3) reflecting plate will be examined. First, if no birefringence exists in the liquid crystal layer, e.g. the liquid crystal layer is vertically oriented, light incident from outside first passes through the circularly polarizing plate (1), and is reflected with its polarized state subjected to no modulation, and the reflected light again passes through the circularly polarizing plate, and proceeds toward the outside, Here, because the light passes through the circularly polarizing plate twice, there is no possibility that the light goes to the outside particularly in a wave range satisfying circularly polarizing conditions. That is, the CPA mode in which the liquid crystal layer is vertically oriented when no voltage is applied has a normally black configuration in the configuration described above. Here, when a voltage is applied, liquid crystal molecules are leaned in a radial form, and therefore they are leaned in all the directions for azimuth directions. In the case of transmission type in which linearly polarized light enters the liquid crystal layer as in the Non-Patent Document 2, the light usage efficiency is reduced when the direction of the molecular axis is identical to the polarizing direction of the polarizing plate, but in the case of a configuration such that circularly polarized light enters the liquid crystal layer, polarized light is equally modulated independently of the direction of the molecular axis in which the liquid crystal is leaned. According to the principle described above, in the case where the reflection display mode and also the CPA mode using a circularly polarizing plate is applied in the configuration of the present invention, a chiral material may be added as described in the Non-Patent Document 2, or a chiral material is not necessarily added.

Application to Transflective Liquid Crystal Display Element

As described in the above conventional technique, a cross-sectional configuration for use in the transflective liquid crystal display element is such that an inter-layer insulation film is provided so that the cell thickness of a transmission area is twice as large as the cell thickness of a reflection area for maximizing light usage efficiencies of both the transmission and reflection areas, and this configuration is well known.

The above well known configuration can be employed in the display element of the present invention.

On the other hand, however, if the above configuration is to be achieved in the display element of the present invention, it is based on a display principle using coloring by birefringent, and therefore a cell thickness larger than that of a liquid crystal display not using the coloring by birefringent such as a twisted nematic (TN) liquid crystal is required. That is, a configuration such that the thickness of inter-layer insulation film is larger than that of a usual transflective liquid crystal display element is required.

Furthermore, if considering the situation in which the transflective liquid crystal display element is used, it is required that display should be provided with sufficient visibility even under very bright external light, high levels of contrast and color reproducibility should be achieved in a room, dark place or the like, and full color digital contents should be reproduced faithfully as described above.

Among them, the requirement that display should be provided with sufficient visibility even under very bright external light can be satisfied by using as a reflection mode a display method based on the display principle of this proposal using coloring by birefringence.

On the other hand, the method described as a basic configuration in this proposal employs a display method utilizing a coloring phenomenon based on the ECB effect and digital gray levels by area division of a pixel for display colors other than the green such as blue and red, and such digital gray levels exceeds the limit of visibility of human beings in a very fine display element, and therefore correspond to perfect full color display, but may be slightly lacking in gray level display capability if the fineness is not necessarily sufficient.

It can be thus considered that for faithfully reproducing digital contents in the transmission mode, a higher gray level display capability is required.

Thus, the present invention employs a micro-color filter mode that is commonly used such that RGB color filters are used for the transmission mode, and the liquid crystal layer continuously changes in transmittance from black to white. That is, the reflection mode provides red and blue display by a mode using coloring with the ECB effect, and green display with a color filter, and the transmission mode provides color display with color filters for all red/green/blue. In this way, the above two items of requirements for the transflective liquid crystal can be made mutually compatible.

By employing an element configuration with display modes different for reflection and transmission, an effective effect different from that by mere combination is exhibited.

As described previously, in the current transflective liquid crystal display element, display methods based on the same principle for a reflection area and a transmission area, and therefore in order that each area exhibits an optimum light usage efficiency, a difference in cell thickness by a factor of 2 should be provided between the reflection area and the transmission area.

For this purpose, an inter-layer insulation film formation process is required as described above.

On the other hand, in the case of the transflective liquid crystal display element employing display modes different for reflection and transmission, specifically employing a mode using coloring with the ECB effect for the reflection mode, and employing a mode not using coloring with the ECB effect for the transmission mode as in this proposal, only display up to blue display should be represented with the ECB effect in the mode using coloring with the ECB effect in the present invention. Thus, for achieving display from black display to blue display in the reflection mode, the retardation amount by the liquid crystal layer (or a combination of the liquid layer and the phase compensation plate) should be capable of being changed within the range of 0 nm to 300 nm by control with voltages.

On the other hand, for achieving display from black display to white display with the ECB effect in the transmission mode, the retardation amount with the liquid crystal layer (or a combination of the liquid crystal layer and the phase compensation plate) should be capable of being changed in the range of 0 nm to about 250 nm by control with voltages.

That is, the cell thickness required in the reflection area is very close to the cell thickness required in the transmission area. Thus, the thickness of the inter-layer insulation film can be considerably reduced compared to the current configuration. Consequently, orientational defects that tend to occur as a result of provision of a difference in cell thickness and a reduction in numerical aperture caused by a taper of a step portion can be inhibited.

Alternatively, if the thickness of the liquid crystal layer is kept constant under conditions such that a thickness of 300 nm or less can be controlled, and the range of amounts controlled with voltages in the transmission mode is limited to a range of 0 nm to 250 nm, the necessity to form the inter-layer insulation film is eliminated. Consequently, simplification of a photolithography process can be achieved, thus making it possible to contribute to a reduction of cost. In addition, uniform orientation is easily achieved, and the numerical aperture can be improved.

Furthermore, in the transflective liquid crystal display element of the present invention, when display is provided in the reflection mode and the transmission mode under the same voltage application conditions, display colors become different for respective modes. In this case, a pixel configuration such that an applied voltage can be controlled independently in the reflection area and the transmission area is more preferable.

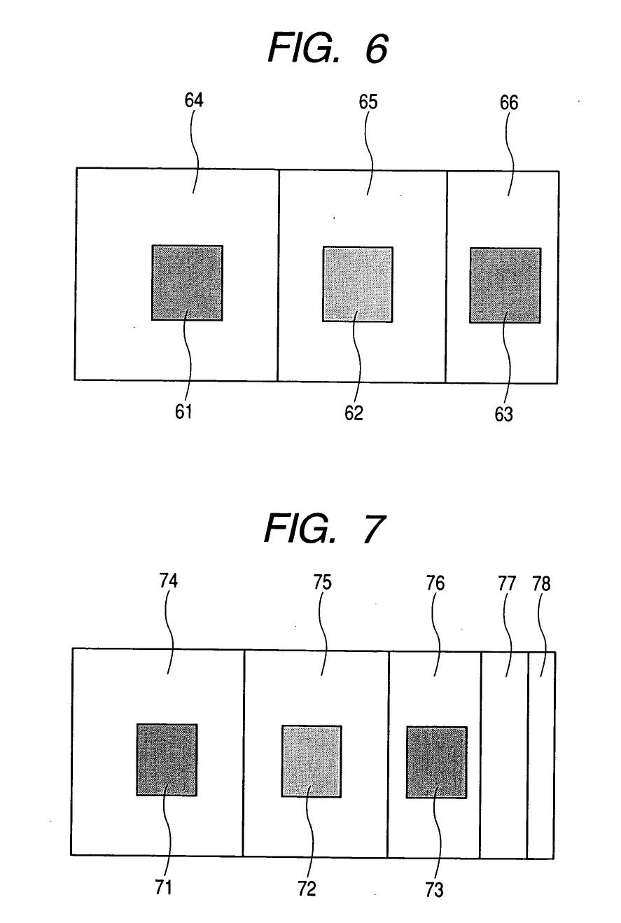

FIG. 6 illustrates a configuration preferred as the transflective liquid crystal display element of the present invention as a result of summarizing the discussion described above.

Reference numerals 61, 62 and 63 in FIG. 6 denote transparent electrodes of ITO. Blue/green/red color filters are formed on optical paths for light passing through these transparent electrodes 61, 62 and 63, respectively. Reference numerals 64, 65 and 66 are reflection electrodes of aluminum or the like. A green color filter is formed on an optical path for light passing through the reflection electrode 65. For this color filter, a reflection type having a reduced color reproduction range may be used for improving the light usage efficiency, or the color filter for transmission type used for the electrode 62 may be formed on only a part of the reflection electrode. No color filters may be formed on reflection electrodes 64 and 66, a color filter of a color complementary to green such as magenta may be formed to enhance the color purity of display colors using coloring with the ECB effect.

Transparent electrodes 61, 62 and 63 are preferably identical in area, and the ratio of the area of the reflection electrode 64 to the area of the reflection electrode 66 is preferably 1:2. Furthermore, it is more preferable that the ratios in area are finely adjusted in consideration of balance of the color filter transmittance. The ratio of the area of a sub-pigment 1 comprised of reflection electrodes 64 and 66 to the area of a sub-pixel 2 comprised of the reflection electrode 65 is preferably finely adjusted as appropriate according to wavelength spectral transmission characteristics of the color filter for use in the sub-pixel 2 to ensure optimum color balance.

In addition, it is more preferable that when the sub-pixel 1 using coloring with the ECB effect is area-divided, a pixel form and a pixel layout method such that a color barycenter for each gray level is not shifted are considered (not shown).

In a general transflective liquid crystal display element, a same voltage is often applied to each of transmission pixels and reflection pixels of transparent electrodes 61, 62 and 63 and reflection electrodes 64, 65 and 66, but the element of the present invention has preferably a configuration in which these six pixels can be voltage-controlled independently because conditions for providing display are different for the reflection mode and the transmission mode.

In addition, as shown in FIG. 7, smaller reflection sub-pixels may be added for increasing the number of gray levels in color display using coloring with the ECB effect in the reflection mode. Furthermore, in FIG. 7, reference numerals 71 to 76 correspond to reference numerals 61 to 66 in FIG. 6, and reference numerals 77 and 78 denote added sub-pixels. Here, in the case where sub-pixels 77 and 78 are added, the ratio of the areas of light reflecting areas is preferably 1:2:4:8: . . . : 2^{N-1} among pixels. The form thereof is not limited to that shown in FIG. 7, but various kinds of electrode forms may be selected.

At this time, the liquid crystal layer in the optically transparent area has an analog gray level capability for each of RGB colors, and therefore it is not necessary that the number of pixels should be increased in the configuration of FIG. 6.

In addition, the method (3) described in the above-described method of enabling the number of colors to be increased may be used in combination for the transflective liquid crystal display element described here. By this combination, full color display can be achieved in both transmission and reflection modes.

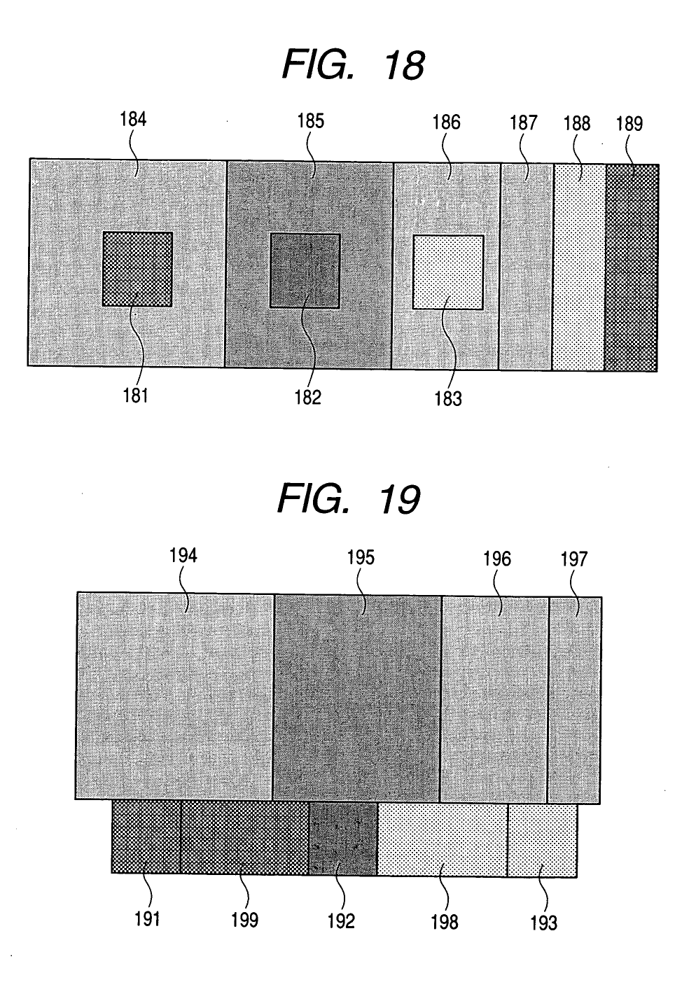

One example thereof is shown in FIG. 18. In FIG. 18, reference numerals 181, 182 and 183 denote pixels providing display of transmission type, which are provided with blue, green and red color filters, respectively. Reference numeral 185 denotes a pixel providing display of reflection type, which is provided with a green color filter. Reference numerals 184, 186 and 187 denote pixels providing display of reflection type, which are capable of providing red and blue color display with a change in color tone using a coloring phenomenon based on the ECB effect. In addition, the pixels 184, 186 and 187 are provided with color filters of colors complementary to green such as a magenta color, and the ratio of the areas of these pixels is 4:2:1. Reference numerals 188 and 189 denote pixels providing display of reflection type, which are provided with red and blue color filters, respectively, and are almost identical in area to the pixel 187.

Consequently, full color display with blue, green and red color filters of transmission-type pixels 181, 182 and 183, and full color display with a pixel configuration of reflection-type pixels 184 to 189 can be provided, and pixels 184, 186 and 187 provide red and blue color display with a change in color tone using a coloring phenomenon based on the ECB effect, thus making it possible to achieve bright full color reflection display.

In this way, in the configuration shown in FIG. 18, full color display can be achieved for both reflection and transmission, and also the color display mode is different for reflection display and transmission display, thus making it possible to obtain an advantage associated with being capable of considerably reducing the thickness of the inter-layer insulation film as described above.

Furthermore, the configuration of FIG. 18 may be rearranged as in FIG. 19. In FIG. 19, reference numerals 191, 192 and 193 denote transmission-type display pixels, which are provided with blue, green and red color filters, respectively. Reference numeral 195 denotes a reflection-type display pixel, which is provided with a green color filter. Reference numerals 194, 196 and 197 are reflection-type display pixels, which are capable of providing red and blue color display with a change in color tone using a coloring phenomenon based on the ECB effect, and are provided with color filters of colors complementary to green such as a magenta color, and the ratio of the areas of these pixels is 4:2:1. Reference numerals 198 and 199 denote reflection-type display pixels, which are provided with red and blue color filters, respectively, and are almost identical in area to the reflection-type display pixel 197.

In this configuration, unlike that of FIG. 18, pixels having color filters for reflection display and transmission display are situated such that they are adjacent to each other. Consequently, this brings about an advantage that a load of fine patterning processing of the color filter can be reduced when common color filters are used as red and blue color filters for reflection and transmission. In addition, when color filters of different spectral transmittance characteristics are used for reflection and transmission as red and blue color filters, influences on display colors can be minimized in case where a slight shift in alignment occurs.

In addition, in both FIGS. 18 and 19, total nine sub-pixels are preferably configured to be capable of being given image information signals independently.

However, if considering the case where the environmental illumination intensity is low and thus a backlight is lit with the transflective liquid crystal display element of the present invention, common image signals may be applied via common electrodes (not shown) to blue pixels 191 and 199 and red pixels 193 and 198 in FIG. 19 because it can be considered that visually recognized as display information is dominantly image information of transmission-type pixels, and the areas of blue and red color filters used for reflection type occupy a relatively small proportion in the entire pixel.

In this way, Concerns may arise that if the environmental illumination intensity is high, display quality is slightly degrade because image information of reflection-type pixels is predominant. However, because red and blue pixels for use in reflection-type display essentially have areas occupying a small proportion in one pixel, and most of image information is determined by a green color filter pixel and pixels using a change in color tone with the ECB effect, it can be considered that degradation of display quality is not significant.

In addition, because generally, the backlight is essentially unlit when the environmental illumination density is high, display can be provided without any problems if desired information signals are applied to reflection-type pixels while the backlight is unlit.

That is, in the case where signals common for the transmission area and the reflection area are applied as image information signals that are applied to red and blue pixels, an information signal to be applied to the transmission area is given a higher priority when the backlight is lit, and an information signal to be applied to the reflection area is given when the backlight is unlit, whereby commonality of means for applying voltages to these pixels can be achieved while minimizing degradation of display quality.

For example, in the case where a display element having a configuration of FIG. 19 is driven using TFT, total nine TFT elements are required for one pixel if all pixels are to be independently driven, while only seven TFT elements should be provided by achieving a configuration such that common information signals are applied as described above.

As described above, the color display mode of the present invention can be used as either a transmission type or reflection type, and is capable of achieving an element of high light usage efficiency. It can also be used as a transflective type but in this case, by using red/blue display principally using coloring with the ECB effect of the present invention, and green display with a color filter in the reflection area, and providing color display with color filters for all red/green/blue in the transmission area, not only a display performance satisfying all requirements for the transflective liquid crystal display element can be achieved, but also the necessity to crate a difference by a factor of 2 in cell thickness in one pixel is eliminated, thus making it possible to satisfy simplification of processes, uniform orientation and an increase in numerical aperture at the same time.

Other Configuration Requirement

For driving the liquid crystal display element of the present invention, any of a direct drive mode, a simple matrix mode and an active matrix mode may be used.

In addition, a substrate for use in the liquid crystal display element may be made of glass or plastic. In the case of transmission type, both of a pair of substrates should be optically transparent but in the case of reflection type, a material impervious to light may be used as a support substrate of the reflection layer. In addition, a deformable material may be used as a substrate that is used.

In addition, in the case of reflection type, various kinds of reflecting plates such as so called a front scattering plate mode such that a scattering plate is provided outside the liquid crystal layer using a mirror reflecting plate, and so called a directional diffusion reflecting plate such that the shape of the reflecting surface is adjusted to provide directivity. In addition, in this embodiment, a vertical orientation mode has been described as one example but in addition thereto, the liquid crystal display element can be applied any mode as long as it is a mode using a change in retardation such as a parallel orientation mode, HAN-type mode or OCB mode.

In addition, in this embodiment, the configuration of normally black such that black display is provided when no voltage is applied has been mainly described as an example. This configuration can be achieved by stacking a circularly polarizing plate and a display layer having no birefringence in the inward direction in the substrate surface when no voltage is applied but in this configuration, the circularly polarizing plate may be replaced by a normal linearly polarizing plate to achieve a configuration of normally white such that white display is provided when no voltage is applied.

Alternatively, a uniaxial retardation film or the like may be stacked in any of these configurations to achieve a configuration such that chromatic display is provided when no voltage is applied. In this case, black and white display can be obtained by deforming a sequence of liquid crystal molecules in a direction in which the retardation amount of the stacked uniaxial retardation film by applying a voltage.

The essence of the present invention is to obtain multi-color display with a high light usage efficiency on the basis of basic principle that continuous gray levels using a color filter are obtained in green display best for visibility characteristics of human beings, thus making it possible to apply a various modes such as a liquid crystal mode having a twisted orientation state such as an STN mode, a selective reflectance mode, and a guest host mode.

Application to Items Other than Liquid Crystal Display Element

The present invention has been described in detail above, centering on the ECB effect of a liquid crystal. However, the basic idea of the present invention is to provide color in which a color filter is applied to a monochromatic display mode for some pixels, and use a display mode in which color change can occur for other pixels. Thus, other than the configuration using the ECB effect, any display modes can be applied for any element to which the above described display mode can be applied.

As an example thereof, (1) mode in which the gap distance of an interference layer is changed by mechanical modulation and (2) mode in which switching is made between display and non-display by moving coloring particles will be described.

The mode (1) has a configuration described in, for example, SID97 Digest p. 71, in which switching is made between display and non-display of an interference color by changing the gap distance from the substrate. Here, switching is made between on and off as a deformable aluminum thin film comes close to or moves away from the substrate by external voltage control. In addition, the color development principle at this time uses interference, and therefore a discussion just same as that for color development by interference using the ECB of a liquid crystal described above holds is established.

Thus, in this gap distance modulation element, an optical properties can be changed by externally controllable modulation means such as a voltage, and a modulation range in which the brightness can be changed by the modulation means between a maximum brightness and a minimum brightness that the element can take, and a modulation range in which a plurality of colors that the element can take can be changed by the modulation means are provided.

For this element, its unit pixel is divided into a plurality of sub-pixels, and at least one of the plurality of pixels is comprised of a sub-pixel 1 capable of providing color display using a modulation range based on the change in color, and a sub-pixel 2 having a color filter, whereby a display element having excellent characteristics such as a high light usage efficiency can be achieved in just the same manner as in the liquid crystal element described above in detail.

For the mode (2), a particle migration display element described in, for example, Japanese Patent Application Laid-Open No. 11-202804, is suitably used. This example is such that switching is made between display and non-display by moving coloring charged migration particles in parallel to the substrate surface in a transparent insulating liquid by application of a voltage between a collect electrode and a display electrode using electrophoretic characteristics.

In addition, this may be applied to achieve a configuration in which two types of color particles are used. Specifically, the mode may have a configuration as a unit cell comprising two display electrodes situated in such a manner that one is almost superimposed on another, and two collect electrodes, two types of particles having mutually different charge polarities and colors and at least one of which is transparent to light, and including drive means capable of forming a state in which the two types of charged particles all collect on the collect electrodes, or a state in which the particles are all placed on the display electrodes, or a state in which any one type of particles are placed on the display electrodes and the other type of particles collect on the collect electrodes, or an intermediate state.

A configuration will be examined in which combinations of colors of two types of migration particles in the unit cell are, for example, blue and red. For providing white display in this case, the cell is driven so that both types of particles collect on the collect electrodes to expose all the display electrodes. In addition, in the case of red or blue single display, the single color is displayed by placing only desired single particles on the display electrodes in the unit cell.

In the case of blue display, for example, blue particles are placed on the display electrodes to form a light absorption layer, and red particles are collected on the collect electrodes. In the case of black display, on the other hand, all particles are placed on the display electrodes to form a light absorption layer, whereby light passes through each of light absorption layers of red particles and blue particles formed in first and second electrodes, and thus black display is provided by subtractive color mixture. In the case of intermediate tone display, only partial particles during black display are placed on the display electrodes. Consequently, the unit cell can modulate the color between chromatic colors of red/blue, and the brightness by display of white/black/intermediate tone.

Accordingly, by using such configurations, a unit pixel is divided into a plurality of sub-pixels, and at least one of the plurality of sub-pixels is comprised of a sub-pixel 1 capable of providing color display using a modulation range based on the change in color, and a sub-pixel 2 having a color filter, whereby a display element having excellent characteristics can be achieved in just the same manner as in the liquid crystal element described above in detail. For example, in this configuration, the above simple basic configuration can be taken in green display having highest visibility characteristics, thus making it possible to obtain a particle migration display element that is excellent in display stability, especially gray level display stability, capable of providing multi-color display and bright.

As described above, according to the present invention, a display element that is bright, capable of providing full color display in terms of visibility or perfect full color display, has a wide viewing angle, and is capable of displaying dynamic picture images without any problems is obtained. Among them, particularly, a reflection liquid crystal display element having a high reflectance, a transflective liquid crystal display element, and a transmission liquid crystal display element having a high transmittance are provided. In addition, this invention can be applied not only to liquid crystal elements, but also to various display modes, and a display element having a high light usage efficiency can be achieved compared to an additive color mixture process using RGB color filters, which has been widely used.

In addition, the need for high color reproducibility such as application for viewing digital contents can be satisfied. Bright color display can be obtained for various kinds of electronic paper techniques that can be achieved by bright monochromatic display.

### EXAMPLES

The present invention will be described in detail using Examples.

Common Element Configuration

The following element configuration was used as a common element configuration for use in Examples.

As a structure of a liquid crystal layer, a configuration similar to that shown in FIG. 3 was used as its basic configuration, and two glass substrates subjected to vertical orientation processing were mated into a cell, into which a liquid crystal material (model name: MLC-6608 manufactured by Merck Ltd.) having a negative dielectric constant anisotropy Δε was injected as a liquid crystal material. Furthermore, at this time, the cell thickness was changed so that retardation became optimum depending on Example.

As substrate structure used, an active matrix substrate having TFT placed thereon was used for one substrate, and a substrate having a color filter placed thereon was used for the other substrate. The pixel form and the color filter configuration at this time were changed depending on Example.

An aluminum electrode was used for a pixel electrode on the TFT side to provide a configuration of reflection type. Furthermore, at this time, a configuration of transflective type using a transmission-type pixel in combination, using an ITO electrode for a pixel electrode on the TFT side was also used depending on Example.

A wideband λ/4 plate (phase compensation plate capable of almost satisfying ¼ wavelength conditions in the visible light range) was placed between an upper substrate (color filter substrate) and a polarizing plate. This resulted in a normally black configuration having a dark state when no voltage is applied during display with a reflection type and having a bright state when a voltage is applied.

### Comparative Example

For comparison, an ECB-type active matrix liquid crystal display panel having a diagonal of 12 inches and 600×800 pixels was used. The pixel pitch is about 300 μm. Each pixel is three-way divided, and the divided pixels are provided red, green and blue color filters, respectively. The liquid crystal layer was adjusted to have a thickness of 3 micrometers so that the central wavelength was 550 nm as reflectance spectral characteristics at the time of applying a voltage of ±5 V, and the retardation amount was 138 nm.

The cell structure is same as that shown in FIG. 3. The surfaces of electrodes 4 and 6 were coated with vertical orientation films (not shown), and in order that liquid crystal molecules were leaned at in a direction of 45° relative to an absorption axis of a polarizing plate 1 at the time of applying a voltage, a pre-tilt angle of about 1□ from the substrate normal was given to the vertical orientation film in the direction described above. Upper and lower substrates 3 and 7 were bonded together to make a cell, into which a liquid crystal material (model name: MLC-6608 manufactured by Merck Ltd.) having a negative dielectric constant anisotropy As was injected as a liquid crystal material and as a result, a liquid crystal 5 was vertically oriented on the substrate surface when no voltage was applied.

For this liquid crystal display element, the voltage was changed in a variety of ways to display images and as a result, continuous gray level colors according to applied voltages for images of RGB is obtained, whereby full color display could be provided, but the reflectance was 16%.

### Example 1

As an active matrix substrate, an active matrix substrate, same as that of Comparative Example, having a diagonal of 12 inches and 600×800 pixels was used.

Each pixel was divided into three sub-pixels, a color filter was used only for green, and remaining other two sub-pixels were kept transparent with no color filters provided therein so that colored display with retardation was used. In addition, the ratio of the areas of these remaining two pixels was 2:1 for area gradation.

The retardation of the liquid crystal layer may have a value that is half the value shown in FIG. 1 because of the reflection type. In order that red display and blue display can be provided, the cell was adjusted to have a thickness of 5 micrometers so that the retardation amount of the transparent pixel at the time of applying a voltage of ±5 V was 300 nm. Conditions for the green pixel were same as those of Comparative Example.

If an image is displayed by changing a voltage for this liquid crystal display element, a change in transmittance according to the value of applied voltage is exhibited and thus continuous gray level characteristics are obtained for a pixel having a green color filter.

For other pixels having no green color filters, blue display is provided at the time of applying a voltage of 5 V, and red display is provided at the time of applying a voltage of 3.8 V, and therefore the liquid display panel of this Example provides display of three primary colors. Furthermore, it displays continuous gray levels according to the magnitude of applied voltage in a range of voltage equal to or less than 3 V.

Furthermore, for red and blue colors, area gradation can be achieved by changing the sub-pixel to be displayed. However, there were only four gray levels as the number of gray levels, and therefore when a natural image was displayed, the image had slight graininess.

Furthermore, the reflectance of this element is 33%, which equals a value twice as large as that of Comparative Example, and thus very bright white display is provided.

### Example 2

Substrates each having 600×800 pixels and having diagonals of 7 inches and 3.5 inches, respectively, were used as active matrix substrates to fabricate ECB-type liquid crystal display elements each having a sub-pixel configuration same as that of Example 1. The pixel pitch was about 180 μm for the substrate having a diagonal of 7 inches, and was about 90 μm for the substrate having a diagonal of 3 inches.

In this case, good characteristics can be obtained for the color display capability as in the case of Example 1. The pixel pitch in this Example is considerably small, and the fineness level is increased, thus making it possible to represent continuous gray levels having no graininess when viewed by eyes even if a natural image is displayed.

The reflectance of this element is 33%, and thus very bright white display us provided compared to Comparative Example.

### Example 3

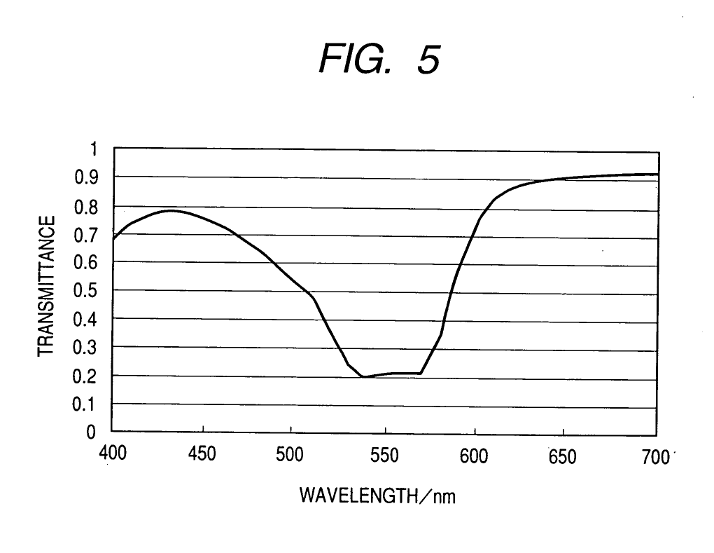

Substrates same as those of Example 2 were used, and a pixel structure having color filters (model name: CM-S571 manufactured by Fuji Film Arch Co., Ltd.) exhibiting transmission spectral characteristics shown in FIG. 5 instead of transparent pixels was employed.

If a coloring phenomenon based on the ECB effect is used, there arises a problem of low purity specific to retardation colors, but if a color filter complementary in color to green is used in combination, tail portions of coloring spectra of red and blue can be cut, and therefore the color purity is improved. When a voltage is applied to a pixel provided with a color filter of this element complementary in color to green, blue display is provided at the time of applying a voltage of 5 V and red display is provided at the time of applying a voltage of 3.8 V as in the case of Example 1, and it is thus recognized that the liquid crystal panel of this Example can provide display of three primary colors.

In a range of voltage equal to or less than 3V, continuous gray level display of magenta can be provided according to the magnitude of applied voltage. In addition, even if a natural image is displayed, continuous gray levels having no graininess when viewed by eyes can be represented as in the case of Example 2.

In addition, the reflectance of this element is 28%, which is slightly lower compared to Example 2, but nevertheless considerably bright white display is provided compared to Comparative Example. For the color display in this Example, color reproduction range is significantly widened on chromaticity coordinates compared to Example 2.

### Example 4

A liquid crystal cell having a configuration same as that of Example 2 except for the cell thickness was used. At this time, a mask-rubbing was used to change a pre-tilt angle, two orientation areas having different director directions is formed, and the cell thickness was set to 5 micrometers for both transparent pixels and green pixels.

At this time, for display quality, bright display and smooth gray level characteristics can be obtained as in the case of Example 3. In addition, wide viewing angle characteristics were obtained. However, because the gap of the green pixel increased, the response speed was reduced, and significant display fades were recognized when dynamic picture images were provided. It can thus be understood that dynamic picture image display characteristics are improved if the cell thickness of the green pixel using a color filter is made to be smaller than the gap of the pixel using retardation.

### Example 5

Using a glass substrate having no reflecting plate was used as a lower plate, an active matrix substrate same as that of Example 1 was prepared to fabricate a liquid crystal display panel.

For electrodes, aluminum electrodes are provided for odd number lines, of 600 lines (scan lines), three sub-pixels are grouped into a sub-pixel having a green color filter and two sub-pixels having no color filters, the ratio of the areas of two sub-pixels having no color filters is 1:2.

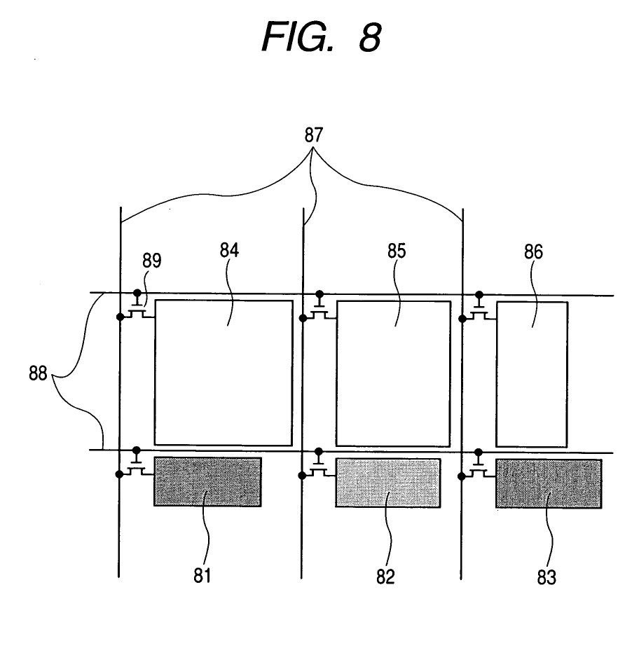

On the other hand, transparent electrodes of ITO are provided for even number lines, and three sub-pixels have the same area. In addition, the three sub-pixels were provided with red/green/blue color filters. The outline of this pixel configuration is shown in FIG. 8. In this figure, reference numerals 84 to 86 denote reflection mode pixels of odd number lines, reference numerals 81 to 83 denote transmission mode pixels of even number lines, reference numerals 87 and 88 denote a source line and a gate line, respectively, and reference numeral 89 denotes a switching element by a thin film transistor. Furthermore, a polarizing plate was placed on the back surface of the panel in such a manner as to have a relation of crossed Nicol with a polarizing plate placed on the upper plate and on the back surface thereof, a backlight was placed and lit.

If an image is displayed on a panel having such a configuration, the characteristics of the reflection mode demonstrated in the above-described Example can be compatible with the characteristics of the transmission mode having display quality equivalent to that of a usual liquid crystal panel. That is, even if all pixels have the same cell thickness, a transflective liquid crystal display element in which the reflection mode having a high reflectance is compatible with the transmission mode having good color reproducibility can be achieved.

### Example 6

Using a substrate similar to that of Example 5, a liquid crystal display element having a configuration same as that of Example 5 is formed except that color filters of magenta color having spectral characteristics shown in FIG. 5 are placed on two pixels having no color filters in which the ratio of the area of one pixel to the area of the other is 1:2 in FIG. 5. In this way, a transflective liquid crystal display element in which the color purity of retardation of red and blue is improved also in the reflection mode and the color reproduction range is widened is achieved.

### Example 7

A substrate same as that of the Comparative Example described above is used as an active matrix substrate. Display of 600×800 pixels is provided with four pixels as one set in this Example, while display of 600×800 pixels (SVGA) is provided with three pixels as one set in Comparative Example.

The color filter is used only for green, and the remaining three sub-pixels are kept transparent so that colored display by retardation is used for the sub-pixels. In addition, for these remaining three pixels, the ratio of the areas was set to 1:2:4 for area gradation.

For retardation of the liquid crystal layer, the cell was adjusted to have a thickness of 5 micrometers so that the retardation amount of the transparent pixel at the time of applying a voltage of ±5 V was 300 nm, in order that red display and blue display could be provided. Conditions for the green pixels were same as those of Example 1.

If an image is displayed by changing the voltage for this liquid crystal element, a change in transmittance according to the value of applied voltage is exhibited, and thus perfect continuous gray level characteristics are obtained for the pixel having a green color filter.

For other pixels having no green color filters, on the other hand, blue color display is provided when a voltage of 5 V is applied, while red color display is provided when a voltage of 3.8 V is applied, and it can thus be recognized that the liquid crystal panel of this Example can provide display of three primary colors. In a range of voltage equal to or less than 3V, the brightness (gray level) is continuously changed according to the magnitude of applied voltage.

For red and blue, area gradation can be achieved by changing sub-pixels to be displayed. In addition, because there are eight gray levels in red and blue, graininess of display is considerably alleviated compared to Example 1. Furthermore, the reflectance of this element is 33%, which is twice as large as the value in comparison with Comparative Example, and thus very bright white display is obtained.

### Example 8

Evaluations were made using the element of Example 7. At this time, the voltage applied to other pixels having no green color filters was continuously changed from 3 V to 5 V. As a result, a continuous change of color from yellow (about 3.2 V) to orange (about 3.6 V) to red (about 3.8 V) to reddish purple (4.0 V) to purple (4.4 V) to bluish purple (4.6 V) to blue (5.0 V) could be recognized. In addition, by changing as appropriate sub-pixels that are displayed, under voltage application conditions for providing display of each color, various display colors are each made to have 8 gray levels.

### Example 9

A liquid crystal display element having a configuration same as that of Example 7 except for color filters was used. At this time, a pixel structure having color filters of magenta color (model name: CM-S571 manufactured by Fuji Film Arch Co., Ltd.) similar to those used in Example 3, as color filters, instead of transparent pixels in Example 7, is employed. For the magenta color filter pixels, the ratio of the areas was set to 1:2:4 for area gradation.

In this case, as in the case of Example 3, blue color display is provided when a voltage of 5 V is applied, while red color display is provided when a voltage of 3.8 V is applied, and thus the liquid crystal panel of this Example can provide display of three primary colors. Continuous gray level display of magenta according to the magnitude of applied voltage can be provided in a range of voltage equal to or less than 3 V. That is, any display color on the arrow mark is displayed in the RB plane already described with FIG. 14.

### Example 10

A substrate same as that of Example 7 was used as an active matrix substrate except that display of 600×400 pixels is provided with six sub-pixels as one set in this Example, while display of 600×600 pixels is provided with four pixels as one set.

For four sub-pixels of the six sub-pixels, one sub-pixel was provided with a green color filter, the other three sub-pixels were provided with magenta color filters complementary in color to green, and the ratio of the areas for the latter sub-pixels was set to 1:2:4. The remaining two pixels were provided with red and blue color filters, respectively. The red and blue color filters were identical in area to the smallest pixel of the three magenta color filters. An adjustment was made so that the area of the green pixel was equal to one-thirds of the total area of the six sub-pixels.

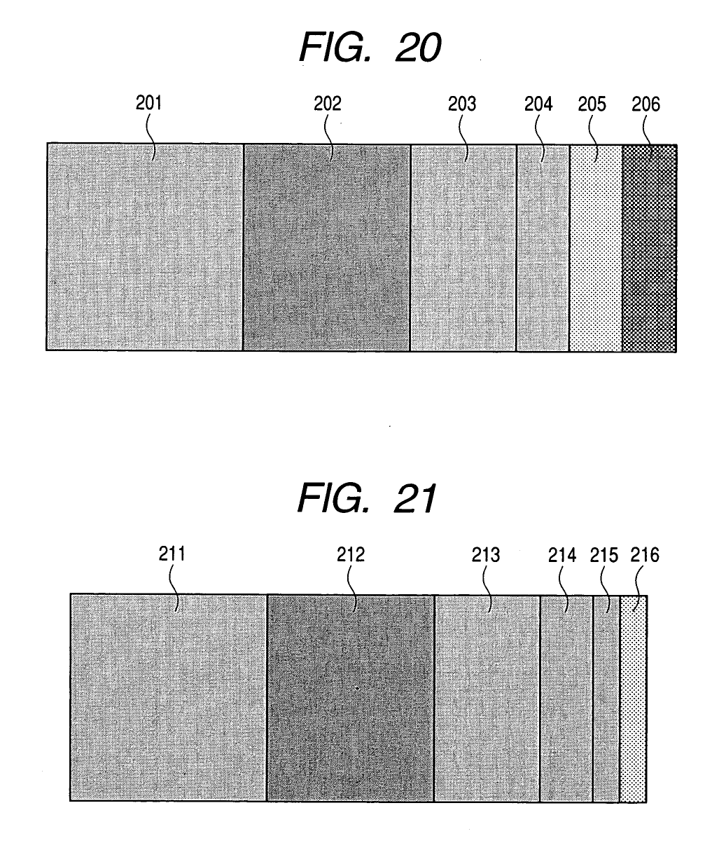

The pixel configuration in this case is shown in FIG. 20. In this figure, reference numeral 202 denotes a green color filter pixel, reference numerals 201, 203 and 204 each denote an area-divided magenta color filter pixel, reference numeral 205 denotes a red color filter pixel, and reference numeral 206 denotes a blue color filter pixel.

By using this configuration, continuous gray levels of magenta in a range of voltage equal to or less than 3 V, red and blue eight gray levels by combination of a coloring phenomenon based on the ECB effect and area division, and red and blue continuous gray levels interpolating the gray levels are achieved. By combining these gray levels, the entire RB plane can be filled. Furthermore, by combining those gray levels with green continuous gray level display, perfect full colors can be achieved.

The reflectance was 25%, which is slightly lower compared to Example 8, but very bright white display could be obtained compared to Comparative Example. In also the color display in this Example, the color reproduction is significantly widened on chromaticity coordinates compared to Example 2, owing to the effect of the magenta color filter.

### Example 11

A substrate same as that of Example 7 was used as an active matrix substrate except that display of 450×400 pixels is provided with eight sub-pixels as one set in this Example, while display of 600×400 pixels is provided with six pixels as one set in Example 10.

Three sub-pixels of the eighth sub-pixels were provided with green, red and blue color filters, respectively. For the remaining five sub-pixels, magenta color filters complementary in color to green were used, and the ratio of the areas was set to 1:2:4:8:16. The areas of the red and blue color filters are equal to the area of the smallest pixel of the five magenta color filters. An adjustment is made so that the area of the green pixel is one-thirds of the total area of the eight sub-pixels.

By using this configuration, continuous gray levels of magenta in a range of voltage equal to or less than 3 V, red and blue 32 gray levels by combination of a coloring phenomenon based on the ECB effect and area division, and red and blue continuous gray levels interpolating the gray levels are achieved. By combining these gray levels, the entire RB plane can be filled. Furthermore, by combining those gray levels with green continuous gray level display, perfect full colors can be achieved.

The reflectance was 27%, which is slightly lower compared to Example 8, but very bright white display could be obtained compared to Example 11, and optical losses by these color filters can be minimized by relatively reducing the areas of red and blue color filters.

### Example 12

As an active matrix substrate, display of 600×400 pixels is provided with six pixels as one set in the same manner as in the Example 10 described above.

For one of these six sub-pixels, a green color filter is used, and magenta color filters complementary in color to green are used for four sub-pixels, of which the ratio of the areas is 1:2:4:8. The remaining one pixel is provided with a red color filter. The area of the red color filter is equal to the area of the smallest pixel of the four magenta color filters. An adjustment is made so that the area of the green pixel is one-thirds of the total area of the six sub-pixels.

The pixel configuration in this case is shown in FIG. 21. In this figure, reference numeral 212 denotes a green color filter pixel, reference numerals 211, 213, 214 and 215 each denote an area-divided magenta color filter pixel, and reference numeral 216 denotes a red color filter pixel.

By using this configuration, continuous gray levels of magenta in a range of voltage equal to or less than 3 V, red and blue 16 gray levels by combination of a coloring phenomenon based on the ECB effect and area division, and red continuous gray levels interpolating the gray levels are achieved. By combining these gray levels, almost the entire RB plane can be filled as described Embodiment although defects partially exist on the plane. Furthermore, by combining those gray levels with green continuous gray level display, a natural image can be almost perfectly reproduced although discontinuities partially exist.

The reflectance was 27%, which is slightly lower compared to Example 7, but very bright white display can be obtained compared to Comparative Example. In also the color display in this Example, the color reproduction is significantly widened on chromaticity coordinates compared to Example 2, owing to the effect of the magenta color filter.

### Example 13

If using the element of Example 12 and using the method already described with FIG. 15, display is provided with a black reference position shifted, the contrast is slightly reduced, but a white reflectance equivalent to that of Example 12 is obtained, and full color display can be provided.

### Example 14

A substrate same as that of Example 7 was used as an active matrix substrate. Display of 400×400 pixels is provided with nine pixels as one set in this Example so that a configuration similar to that of FIG. 18 described previously is achieved, while display of 600×400 pixels is provided with six pixels as one set in Example 11. The cell thickness in this case is 5 micrometers for all pixels. Aluminum reflection electrodes were used for six pixels of the nine pixels, and the pixel configuration was identical to that of Example 10. The remaining three pixels were optically transparent pixels with ITO electrodes used for both upper and lower substrates.

A polarizing plate is placed on the back surface of the panel so as to have a relation of crossed Nicol with a polarizing plate placed on the upper substrate and on the back surface thereof, a backlight is placed and lit.

If a desired voltage is applied independently to each pixel to display an image on a panel having such a configuration, characteristics of the reflection mode described in the Example described previously can be compatible with characteristics of the transmission mode having display quality equivalent to a usual liquid crystal panel.

Consequently, even if all pixels have the same cell thickness, use of this configuration can achieve a transflective liquid crystal display element in which the full color reflection mode having a high reflectance is compatible with the transmission mode having good color reproducibility characteristics.

### Example 15

Evaluations were made using the element of Example 14. At this time, the same voltage is applied to pixels 181 and 189 and pixels 183 and 188 described previously with FIG. 18. At this time, assuming that the condition for application of an image information signal voltage most suitable for reflection-type display is C(R), and the condition for application of an image information signal voltage most suitable for transmission-type display is C(T), evaluations on images were made in places of different environmental illumination intensities. First, when an image is displayed with a backlight being lit in a dark place, an image to be displayed originally cannot be obtained under the condition C(R), while a desired image is displayed under the condition C(T).

If the backlight is unlit in the dark place, under any condition the image is so dark that evaluations cannot be made, but if the image is displayed in an outdoor bright place with the backlight being lit, a desired image is displayed under the condition C(R) and even under the condition C(T), almost a desired image is displayed although a subtle sense of incompatibility is felt.

When an image is displayed in an outdoor bright place with the backlight being unlit, a desired image is displayed under the condition C(R), and even under the condition C(T), almost a desired image is displayed although a subtle sense of incompatibility is felt.

From the above, in general, an image may be displayed under the voltage application condition C(T) when the backlight is lit, and an image may be displayed under the voltage application condition C(R) when the backlight is unlit although a subtle sense of incompatibility is felt. In addition, because the backlight is generally unlit in a bright place, it can be understood that a desired image can be obtained on every occasion as long as the backlight is unlit in a bright place.

In addition, consequently, practically sufficient characteristics can be obtained if the same voltage is applied to pixels 181 and 189 and pixels 183 and 188, and therefore it can be understood that the number of TFTs required in this configuration can be reduced from 9 per pixel to 7 per pixel.

As described above, a bright reflection liquid crystal display element and transflective liquid crystal display element can be achieved according to this Example. Furthermore, in this Example, the present invention has been described centering on direct-vision reflection liquid crystal display elements and direct vision transflective liquid crystal display elements, but this may be applied to liquid crystal display elements such as direct-vision transmission liquid crystal display elements and projection liquid crystal display elements, and view finders using expanded optical systems.

Furthermore, TFT is used as a drive substrate in this Example, but alterations of the substrate configuration such as use of MIM instead, and use of a switching element formed on a semiconductor substrate, and alterations of the drive method such as simple matrix drive and plasma matrix addressing drive can be made as a matter of course.

In addition, in this Example, the present invention has been described centering on the vertical orientation mode, but this can be applied to any mode using a change in retardation by application of a voltage such as a parallel orientation mode, a HAN-type mode and an OCB mode. In addition, the present invention can be applied to a liquid crystal mode having a twisted orientation mode such as an STN mode.

In addition, an effect equivalent to that of this Example can be achieved even if a mode of changing a gap distance that is the thickness of air as a medium for an interference layer by mechanical modulation is used instead of a liquid crystal element having an ECB effect. In addition, an effect equivalent to that of this Example can be achieved even if a particle migration display element based on the configuration described in Embodiment in which a plurality of particles as a medium are moved by application of a voltage is used as a display apparatus.

Alternatively, the present invention can be applied to a so-called electrophoresis display device, in which charged colored particles are dispersed in a liquid and made to migrate by electric field.

In the present invention applied to such electrophoresis display device is used, a plurality of the particles as the medium is made to migrate by application of voltage.

The electrophoresis device to which the present invention is applied is comprised of a constitution of locating on the first sub-pixel an electrophoresis liquid in which at least two kinds of particles showing different particle-migrating properties and colorations have been dispersed in an insulating liquid, and locating on the second sub-pixel having a color filter layer an electrophoresis liquid in which one kind or more of particles has been dispersed.

In the first sub-pixel, two display electrodes and two collecting electrodes are located. The display electrodes are located at a position where they are almost superimposed to each other in the direction of an observer's eye. The collecting electrodes are opaque and located at a position which the observer cannot look at. Both the display electrodes are transparent or one of them is reflective, particles on which can be recognized by the observer's eye.

The two kinds of particles show different particle-migrating properties and colorations to each other, at least one of which kinds is light-transmittable. The electrophoresis liquid preferably has red and black particles positively and negatively charged respectively and dispersed in the liquid.

The color modulation range of the present invention is formed by a state that all of two kinds of particles gather at the collecting electrode or are located at the display electrodes, or a state any one of the kinds of particles is located at the display electrode and the other gathers at the collecting electrode, or an intermediate state between them.

The second sub-pixel changes an amount of reflective or transmitting light by using reflection or absorption by the particles. The light passes through the color filter during the transmitting or reflecting. A preferable example is a display device in which black particles are dispersed in a liquid and opaque collecting electrodes and transparent display electrodes are formed in a pixel. The brightness modulation range of the present invention includes a state of spreading the particles on the display electrode to make them absorb external light, a state of making the particles gather at the collecting electrode to make them transmit or reflect external light and an intermediate state of the former two states.

1. A color display element comprising a unit pixel which is comprised of a plurality of sub-pixels comprising a first sub-pixel and a second sub-pixel having a color filter and a medium which has an optical property modulated in accordance with a voltage applied to each of the sub-pixels and is located in each of the sub-pixels, wherein,
the color display element has a means of applying to the first sub-pixel a voltage which modulates an optical property of the medium located in the first sub-pixel in a range within which a brightness of light passing through the medium is variable and in a range within which a chromatic color assumed by light passing through the medium changes, and a means of applying to the second sub-pixel a voltage which modulates an optical property of the medium located in the second sub-pixel in a range within which a brightness of light passing through the medium is variable.

2. The color display element according to claim 1, wherein the color filter of the second sub-pixel is comprised of a green color filter.

3. The color display element according to claim 2 wherein the range within which the color changes is a color range of red, blue and colors between them.

4. The color display element according to claim 2, wherein a voltage making the light passing through the medium assume magenta intermediate between red and blue is applied to the first sub-pixel, and a voltage making the light passing through the medium has a maximum brightness in the range within which a brightness of the light is variable is applied to the second sub-pixel, whereby the unit pixel displays white color.

5. The color display element according to claim 1, wherein the first sub-pixel has a color filter of a color complementary to a color of the color filter of the second sub-pixel.

6. The color display element according to claim 5, wherein the color filter of the second sub-pixel assumes green, and the color filter of the first sub-pixel assumes magenta.

7. The color display element according to claim 5, wherein a voltage in the range within which the color changes is applied to the first sub-pixel, to display a color as a result of overlapping the chromatic color and a color of the complementary color filter with each other.

8. The color display element according to claim 5, wherein a voltage making the lights passing through the mediums have a maximum brightness in the range within which a brightness of the light is variable is applied to the first and second sub-pixels, whereby the unit pixel displays white color.

9. The color display element according to claim 5, wherein modulations of a same gray level in the range within which a brightness of the light is variable are applied to the first and second sub-pixels respectively, whereby an achromatic color of half tone is displayed in the unit pixel.

10. The color display element according to claim 2, wherein the second sub-pixel is comprised of two or more of sub-pixels, at least one of which sub-pixels has a red color filter or a blue color filter.

11. A color display element comprising at least one polarizing plate, a pair of substrates opposite to each other in which an electrode is formed, and a liquid crystal layer located between the substrates, wherein the retardation of the liquid crystal layer is variable according to a voltage applied to the electrode, and
a unit pixel of the color display element is comprised of a plurality of sub-pixels comprising a first sub-pixel wherein the retardation of the liquid crystal layer is modulated according to the voltage applied to the electrode in a range within which a brightness of light passing through the liquid crystal layer is variable and in a range within which a chromatic color assumed by light passing through the liquid crystal layer changes and a second sub-pixel having a color filter wherein the retardation of the liquid crystal layer is modulated according to the voltage applied to the electrode in a range within which a brightness of light passing through the liquid crystal layer is variable.

12. The color display element according to claim 11, wherein a liquid crystal of the liquid crystal layer is orientated in a direction almost perpendicular to the substrate when the voltage is not applied and inclines the orientation from the almost perpendicular state in accordance with an application of the voltage.

13. The color display element according to claim 11, wherein an orientation of a liquid crystal of the liquid crystal layer varies over a range between a bend orientation and an almost perpendicular orientation in accordance with an application of the voltage.

14. The color display element according to claim 11, wherein a thickness of a cell of the second sub-pixel is smaller than that of the first sub-pixel.

15. The color display element according to claim 11, wherein the unit pixel is comprised of a third sub-pixel having a color filter, the first and second sub-pixels have a region reflecting light respectively, and the third sub-pixel has a region which transmits a light from the rear through the color filter.

16. The color display element according to claim 15, wherein the third sub-pixel is a sub-pixel wherein the retardation of the liquid crystal layer is modulated according to the voltage applied to the electrode in a range within which a brightness of light passing through the liquid crystal layer is variable.

17. The color display element according to claim 16, wherein a thickness of a liquid crystal layer in the light-transmitting region of the third sub-pixel is smaller than twice the thickness of the liquid crystal layers in the light-reflecting regions of the first and second sub-pixels.

18. The color liquid crystal display element according to claim 17, wherein the thickness of the liquid crystal layer of the light-reflecting region is equal to the thickness of the liquid crystal layer of the light-transmitting region, and makes it possible to modulate the retardation in a range from 0 nm to 300 nm.

19. The color display element according to claim 15, wherein the third sub-pixel is composed of three sub-pixels having red, green and blue color filters respectively.

20. The color display element according to claim 19, wherein each of the three sub-pixels is a sub-pixel in which the retardation of the liquid crystal layer is modulated according to the voltage applied to the electrode in a range within which a brightness of light passing through the liquid crystal layer is variable.

21. A method for driving a color display element which contains a medium an optical property of which changes in accordance with an applied voltage, the element being comprised of a unit pixel comprised of a plurality of sub-pixels comprising a first sub-pixel and a second sub-pixel having a color filter, which comprises the steps of:
applying to the first sub-pixel a voltage modulating an optical property of the medium in a range within which a brightness of light passing through the medium is variable and in a range within which a chromatic color assumed by light passing through the medium changes, and
applying to the second sub-pixel a voltage modulating an optical property of the medium in a range within a brightness of light passing through the medium is variable.

22. A color display apparatus comprising a unit pixel which is comprised of a plurality of sub-pixels comprising a first sub-pixel and a second sub-pixel having a color filter, at each of which sub-pixels a means of applying a voltage and a medium which has an optical property modulated in accordance with a voltage applied by the means are located, wherein
the means of applying the voltage is comprised of a means of applying to the first sub-pixel a voltage which modulates an optical property of the medium in a range within which a brightness of light passing through the medium is variable and in a range within which a chromatic color assumed by light passing through the medium changes, and a means of applying to the second sub-pixel a voltage which modulates an optical property of the medium in a range within which a brightness of light passing through the medium is variable.

23. A color display apparatus comprising a unit pixel which is comprised of a first sub-pixel having a light-reflective surface, a second sub-pixel having a light-reflective surface and a color filter and a third sub-pixel having a color filter which sub-pixel transmits a light from the rear through the color filter, a means of applying a voltage to each of the sub-pixels and a medium which has an optical property modulated in accordance with the applied voltage, wherein
the means of applying a voltage to each of the sub-pixels is comprised of a means of applying to the first sub-pixel a voltage which modulates an optical property of the medium in a range within which a brightness of light passing through the medium is variable and in a range within which a chromatic color assumed by light passing through the medium changes, and a means of applying to the second and third sub-pixels respective voltages which modulate an optical property of the medium in a range within which a brightness of light passing through the medium is variable.

24. The color display apparatus according to claim 23, the means of applying voltages to the first through third sub-pixels are respectively comprised of an electrode and an active matrix substrate on which gate lines, source lines and TFTs are located, the odd number gate lines being connected to the electrodes of the first and second sub-pixels through the TFT, and the even number gate lines being connected to the electrode of the third sub-pixel through the TFT.

25. The color display apparatus according to claim 23, wherein the first sub-pixel is comprised of two sub-pixels, and the third sub-pixel is comprised of three sub-pixels having red, green and blue color filters respectively.

26. The color display apparatus according to claim 25, wherein the three sub-pixels in the third sub-pixel are located adjacent to the second sub-pixel and the two sub-pixels of the first sub-pixel, respectively.

27. The color display apparatus according to claim 26, wherein the first sub-pixel has a color filter of a color complementary to a color of the color filter of the second sub-pixel, and the sub-pixel of the third sub-pixel which is adjacent to the second sub-pixel has a color filter of a same color as of the color filter of the second sub-pixel.

28-29. (canceled)
